(19) United States
(12) Patent Application Publication
(10) Pub. No.: US 2026/0329939 A1
(43) Pub. Date: Oct. 22, 2026

(54) K-Shot Selection Using Combinatorial Bandit

(71) Applicant: GDM Holding LLC, Mountain View, CA (US)

(72) Inventors: Victor Carbune, Zürich (CH); Hassan Mansoor, London (GB); Gábor Bartók, Zürich (CH)

(21) Appl. No.: 19/180,764

(22) Filed: Apr. 16, 2025

(51) Int. Cl. G06F 16/903; G06F 16/9035

(52) U.S. Cl. CPC G06F 16/90335; G06F 16/9035

(57) ABSTRACT

A computing system comprising one or more computing devices can obtain, in each of a plurality of iterations, one or more queries directed to one or more machine-learned models. The computing system can perform, in each of the plurality of iterations, based at least in part on first data indicative of an exploration-exploitation tradeoff, a plurality of selection operations to obtain a plurality of selected input portions. The machine-learned model can generate, in each of the plurality of iterations, based at least in part on an input context comprising a combination of the plurality of selected input portions, one or more inference outputs. The computing system can update, in each of the plurality of iterations, based at least in part on feedback data associated with the one or more inference outputs, the first data indicative of the exploration-exploitation tradeoff.

### BACKGROUND

The present disclosure relates generally to machine learning processes and machine-learned devices and systems. A computer can receive input(s). The computer can execute instructions to process the input(s) to generate output(s) using a parameterized model.

The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include, for each of a plurality of iterations, obtaining, by a computing system comprising one or more computing devices, one or more queries directed to one or more machine-learned models. The example method can include, for each of the plurality of iterations, performing, by the computing system based at least in part on first data indicative of an exploration-exploitation tradeoff, a plurality of selection operations to obtain a plurality of selected input portions. In the example method, each selection operation of the plurality of selection operations can include selecting, from a plurality of candidate input portions, one or more respective input portions of the plurality of selected input portions. The example method can include, for each of the plurality of iterations, generating, by the one or more machine-learned models based at least in part on an input context comprising a combination of the plurality of selected input portions, one or more inference outputs associated with the one or more queries. The example method can include, for each of the plurality of iterations, obtaining, by the computing system, feedback data indicative of a suitability of the one or more inference outputs. The example method can include, for each of the plurality of iterations, updating, by the computing system based at least in part on the feedback data, the first data indicative of the exploration-exploitation tradeoff.

In the example method, the plurality of candidate input portions can be a first plurality of candidate input portions. The example method can include selecting, by the computing system prior to performing the plurality of selection operations, the first plurality of candidate input portions from a second plurality of candidate input portions. In the example method, the first plurality of candidate input portions can be a subset of the second plurality of candidate input portions.

In the example method, selecting the first plurality of candidate input portions can include deduplication based at least in part on a metric of similarity between pairs of candidate input portions of the second plurality of candidate input portions.

In the example method, selecting the first plurality of candidate input portions can include clustering the second plurality of candidate input portions.

In the example method, the plurality of candidate input portions can be a first plurality of candidate input portions. In the example method, the one or more machine-learned models can be one or more first machine-learned models. The example method can include determining, based at least in part on one or more example input portions, the first plurality of candidate input portions. In the example method, determining the first plurality of candidate input portions can include providing, by the computing system to the one or more first machine-learned models or one or more second machine-learned models, an input context comprising the one or more example input portions. In the example method, determining the first plurality of candidate input portions can include receiving, by the computing system from the one or more first machine-learned models or the one or more second machine-learned models, at least a portion of the first plurality of candidate input portions.

In the example method, the plurality of selection operations can include one or more first selection operations to select one or more first selected input portions of the plurality of selected input portions. In the example method, the plurality of selection operations can include one or more second selection operations. In the example method, the one or more second selection operations can be based at least in part on a metric of similarity between the one or more first selected input portions and one or more candidate input portions of the plurality of candidate input portions.

In the example method, at least one selection operation of the plurality of selection operations can include selecting based at least in part on a metric of similarity between the one or more queries and one or more candidate input portions of the plurality of candidate input portions.

In the example method, the metric of similarity can include a metric of distance between a first machine-learned embedding associated with the one or more queries and a second machine-learned embedding associated with the one or more candidate input portions.

In the example method, the first data indicative of the exploration-exploitation tradeoff can include second data indicative of one or more performance metrics associated with one or more candidate input portions of the plurality of candidate input portions; and third data indicative of a degree to which exploration is to be prioritized in a current iteration of the plurality of iterations.

In the example method, performing the plurality of selection operations based on the first data can include processing, by the computing system based at least in part on the one or more queries, the first data to generate second data indicative of the exploration-exploitation tradeoff.

In the example method, the first data can include performance data. In the example method, processing the first data can include at least one of filtering the performance data and weighting the performance data. In the example method, processing the first data can be based at least in part on at least one of a machine-learned embedding of the one or more queries, a category associated with the one or more queries, and a machine-learned output generated based on the one or more queries.

In the example method, the one or more machine-learned models can include one or more multimodal vision-language machine-learned models. In the example method, the one or more queries can include one or more natural language queries. In the example method, each of one or more candidate input portions of the plurality of candidate input portions can include an image.

In the example method, the one or more machine-learned models can include one or more multimodal machine-learned models. In the example method, the one or more respective input portions can include one or more multimodal input portions.

In the example method, the one or more inference outputs can include at least one of: one or more visual question answering outputs; one or more graphical user interface automation outputs; and one or more content recommendation outputs recommending one or more multimodal content items to provide responsive to the one or more queries.

The example method can include, for each of the plurality of iterations, selecting, by the computing system, at least one of: a number of candidate input portions to select; an input template or input format for processing the selected input portions; a system prompt to be combined with the selected input portions; a tokenization method for tokenizing the one or more queries; a diversity hyperparameter indicative of a degree to which a diversity of selected input portions is to be prioritized in the plurality of selection operations; a similarity hyperparameter indicative of a degree of similarity between the one or more queries and the selected input portions; and a selected method for combining the plurality of selected input portions. In the example method, the selected method can be selected from a plurality of candidate methods comprising one or more of: concatenation; machine-learned combination using the one or more machine-learned models; machine-learned combination using a different machine-learned model; and combining a plurality of respective embedding values associated respectively with the plurality of selected input portions.

In the example method, the plurality of selected input portions can include a plurality of example input-output tuples, each input-output tuple comprising an example input query and an example output associated with the example input query.

In the example method, the plurality of example input-output tuples can include a plurality of input-reasoning-output tuples. In the example method, each input-reasoning-output tuples can include one or more example reasoning outputs associated with the example input query and the example output.

In the example method, the one or more machine-learned models can be one or more first machine-learned models and the plurality of iterations can be a first plurality of iterations. The example method can include updating, by the computing system, the first data to increase a degree to which exploration is to be prioritized in one or more iterations of a second plurality of iterations. The example method can include, for each of the second plurality of iterations, obtaining, by the computing system, one or more queries directed to one or more second machine-learned models different from the one or more first machine-learned models.

The example method can include, for each of the second plurality of iterations, performing, by the computing system based at least in part on the first data, a plurality of selection operations to obtain a plurality of selected input portions. In the example method, each selection operation of the plurality of selection operations can include selecting, from a plurality of candidate input portions, one or more respective input portions of the plurality of selected input portions. The example method can include, for each of the second plurality of iterations, generating, by the one or more second machine-learned models based on an input context comprising a combination of the plurality of selected input portions, one or more inference outputs. The example method can include, for each of the second plurality of iterations, obtaining, by the computing system, feedback data indicative of a suitability of the one or more inference outputs. The example method can include, for each of the second plurality of iterations, updating, by the computing system based at least in part on the feedback data, the first data.

Example aspects of the present disclosure provide an example computing system that includes one or more processors and one or more example non-transitory computer-readable media storing instructions that are executable by one or more processors to cause a computing system to perform example operations. In some implementations, the example operations can include, for each of a plurality of iterations, obtaining one or more queries directed to one or more machine-learned models. In some implementations, the example operations can include, for each of the plurality of iterations, performing, based at least in part on first data indicative of an exploration-exploitation tradeoff, a plurality of selection operations to obtain a plurality of selected input portions. In the example operations, each selection operation of the plurality of selection operations can include selecting, from a plurality of candidate input portions, one or more respective input portions of the plurality of selected input portions. In some implementations, the example operations can include, for each of the plurality of iterations, generating, by the one or more machine-learned models based at least in part on an input context comprising a combination of the plurality of selected input portions, one or more inference outputs associated with the one or more queries. In some implementations, the example operations can include, for each of the plurality of iterations, obtaining feedback data indicative of a suitability of the one or more inference outputs. In some implementations, the example operations can include, for each of the plurality of iterations, updating, based at least in part on the feedback data, the first data indicative of the exploration-exploitation tradeoff.

Example aspects of the present disclosure provide one or more example non-transitory computer-readable media storing instructions that are executable by one or more processors to cause a computing system to perform example operations. In some implementations, the example operations can include, for each of a plurality of iterations, obtaining one or more queries directed to one or more machine-learned models. The example operations can include, for each of the plurality of iterations, performing, based at least in part on first data indicative of an exploration-exploitation tradeoff, a plurality of selection operations to obtain a plurality of selected input portions. In the example method, each selection operation of the plurality of selection operations comprises selecting, from a plurality of candidate input portions, one or more respective input portions of the plurality of selected input portions. The example operations can include, for each of the plurality of iterations, generating, by the one or more machine-learned models based at least in part on an input context comprising a combination of the plurality of selected input portions, one or more inference outputs associated with the one or more queries. The example operations can include, for each of the plurality of iterations, obtaining feedback data indicative of a suitability of the one or more inference outputs. The example operations can include, for each of the plurality of iterations, updating, based at least in part on the feedback data, the first data indicative of the exploration-exploitation tradeoff.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram of an example system for input combination selection according to example implementations of aspects of the present disclosure;

FIG. 2 is a block diagram of an example system for determining a set of candidate input portions for input combination selection according to example implementations of aspects of the present disclosure;

FIG. 3 is a block diagram of an example system for hyperparameter selection according to example implementations of aspects of the present disclosure;

FIG. 4 is a block diagram of a portion of an example system for query-specific input combination selection according to example implementations of aspects of the present disclosure;

FIG. 5 is a block diagram of an example system for input combination selection for a second machine-learned model based on data associated with a first machine-learned model according to example implementations of aspects of the present disclosure;

FIG. 6 is a block diagram of an example system for visual question answering according to example implementations of aspects of the present disclosure;

FIG. 7 is a block diagram of an example system for content recommendation according to example implementations of aspects of the present disclosure;

FIG. 8 is a block diagram of an example system for graphical user interface (GUI) automation according to example implementations of aspects of the present disclosure;

FIG. 9 is a flow chart diagram of an example method for input combination selection according to example implementations of aspects of the present disclosure;

FIG. 10 is a flow chart diagram illustrating an example method for training a machine-learned model according to example implementations of aspects of the present disclosure;

FIG. 11 is a block diagram of an example processing flow for using machine-learned model(s) to process input(s) to generate output(s) according to example implementations of aspects of the present disclosure;

FIG. 12 is a block diagram of an example sequence processing model according to example implementations of aspects of the present disclosure;

FIG. 13 is a block diagram of an example technique for populating an example input sequence for processing by a sequence processing model according to example implementations of aspects of the present disclosure;

FIG. 14 is a block diagram of an example model development platform according to example implementations of aspects of the present disclosure;

FIG. 15 is a block diagram of an example training workflow for training a machine-learned model according to example implementations of aspects of the present disclosure;

FIG. 16 is a block diagram of an inference system for operating one or more machine-learned model(s) to perform inference according to example implementations of aspects of the present disclosure;

FIG. 17 is a block diagram of an example networked computing system according to example implementations of aspects of the present disclosure;

FIG. 18 is a block diagram of an example computing device according to example implementations of aspects of the present disclosure; and

FIG. 19 is a block diagram of an example computing device according to example implementations of aspects of the present disclosure.

### DETAILED DESCRIPTION

Generally, the present disclosure is directed to systems and methods for selecting, using a combinatorial multi-armed bandit technique, an input combination to be provided to a machine-learned model. An input combination can include, for example, a plurality of K-shot examples (e.g., few-shot examples, many-shot examples, chain-of-thought examples, etc.) or other input portions to be combined and provided to the machine-learned model (e.g., in combination with a query such as a user query, etc.). For example, at each of a plurality of iterations, a computing system can select, according to an exploration-exploitation tradeoff, a plurality of input portions; generate, based on a combination of the plurality of input portions, an output; and update, based on feedback data associated with the output, reward data correlating the feedback received to the input portions used to generate the output. In later iterations, the input portions can be selected based at least in part on the updated reward data. For example, selecting according to an exploration-exploitation tradeoff can include selecting better-performing input portions at a higher rate than worse-performing input portions (“exploiting” the better-performing options), while continuing to sometimes select (e.g., randomly select, etc.) potentially worse-performing input portions (e.g., untested input portions with unknown performance characteristics, etc.) to continue gathering feedback data on a variety of input portion combinations (“exploring” the input possibilities). In some instances, an exploration-exploitation tradeoff can include placing a higher priority on exploration in earlier iterations, and a higher priority on exploitation in later iterations, possibly including an exploitation-only strategy after a threshold amount of data has been gathered.

In some instances, various strategies can be employed to reduce a computational complexity of the selection problem and to reduce an amount of feedback data needed to achieve improvements in output quality. For example, in an alternative naïve implementation, determining an optimal combination of input portions could include separately testing every possible combination of input portions on each query of a set of queries (e.g., benchmark dataset, etc.). However, in some state-of-the-art systems (e.g., machine-learned models having million-token context windows, etc.), an appropriate input combination may include thousands (e.g., 2,048, etc.) of K-shot examples, and these examples may be selected from a much larger dataset, such as a dataset comprising tens of thousands, hundreds of thousands, or millions of data examples. In such instances, a computational cost of testing every possible combination can increase exponentially with respect to a size of the input combination or with respect to a size of a dataset of candidate input portions, such that testing every possible combination may be computationally infeasible, computationally expensive, or otherwise undesirable.

In some instances, one or more strategies described herein can be employed to reduce a computational complexity of collecting feedback data and improving a quality of input combinations based on the feedback data. For instance, in some instances, a combinatorial selection strategy can be used. As used herein, combinatorial selection can mean that, instead of testing every input combination separately, portions of the input combination can be mixed and matched, and feedback data for each input portion can be collected based on feedback associated with all combinations that included that input portion. In this manner, for instance, a computational cost of collecting feedback data can be reduced (e.g., from O(2^{N}) to O(N), where N is a number of candidate input portions to select from, etc.). As another example, in some instances, feedback data can be collected on an ongoing basis (e.g., instead of one-time up-front testing, etc.). For example, a user can provide a query; a computing system can select an input combination according to an exploration-exploitation tradeoff based on feedback collected so far; and the computing system can update the feedback data with feedback collected from the user. Various strategies described herein can be used to optimize or nearly optimize the exploration-exploitation tradeoff to make the most of feedback data at each user feedback iteration.

As another example, in some instances, a large dataset of candidate input portions can be reduced to generate a smaller set of candidate input portions to select from, thereby reducing a cost of collecting feedback on the smaller selection space. For example, in some instances, generating a smaller set of candidate input portions can include deduplication, wherein candidate input portions that are too similar to each other (e.g., according to a similarity metric threshold, etc.) can be removed from the dataset. As another example, in some instances, generating a smaller set of candidate input portions can include clustering the larger dataset of candidate input portions (e.g., based on machine-learned embeddings of each candidate input portion, etc.), and performing selection and feedback operations based at least in part on the clustering. As another example, in some instances, generating a smaller set of candidate input portions can include providing part of a larger dataset (e.g., some number of input examples at a time, such as 20, 100, 1000, etc.; one cluster at a time; etc.) to a machine-learned model in combination with an instruction to reduce the provided input to a smaller set of input portions (e.g., by summarizing or combining the input examples; by selecting a subset of the input examples; etc.).

In some instances, a combinatorial selection strategy can include combinatorial selection of one or more hyperparameters, such as one or more selection hyperparameters used in selecting the input portions, one or more combination hyperparameters for combining the input portions, or other hyperparameters (e.g., tokenizer hyperparameters, etc.). A selection hyperparameter can include, for example, a number of input portions to select and include in an input combination; a similarity hyperparameter indicating how similar the selected input portions should be to an input query; a diversity hyperparameter indicating how different the selected input portions should be from each other; or other selection parameter. A combination hyperparameter can include, for example, a format or template for processing the input portions (e.g., delimiter tags such as “Input:”, “Output:”, etc.), an additional input (e.g., system prompt, etc.) to be combined with the input portions, a method for combining the input portions (e.g., concatenation; pooling of embedding values; machine-learned combination; etc.), or other parameter for combining the selected input portions. In some instances, hyperparameters can be selected in combination with the input portions according to a combinatorial selection strategy (e.g., combinatorial multi-armed bandit strategy based on an exploration-exploitation tradeoff, etc.) encompassing both the hyperparameter selection and input portion selection. For example, each combination of hyperparameter(s) and input portions selected according to the hyperparameters can be viewed together as a combined “super-arm” of a combinatorial multi-armed bandit selection operation, and the hyperparameters and input portions can be selected according to one or more combinatorial multi-armed bandit selection operations described herein.

In some instances, one or more selections (e.g., hyperparameter selections, input portion selections, etc.) for each query (e.g., user query) can be based at least in part on the query itself. For example, in some instances, a machine-learned embedding of the query can be generated, and one or more input portions can be selected based at least in part on a metric of similarity between the query embedding and one or more input portion embeddings. As another example, in some instances, query-dependent feedback data can be collected or generated, and one or more selection operations can be based at least in part on the query-dependent feedback data. As a non-limiting illustrative example, generating query-dependent feedback data can include weighting feedback data based on a similarity between the current query and a query for which the feedback data was collected; filtering feedback data based on a category or classification of the current query; or the like.

In some instances, systems and methods described herein can include input combination selection for multimodal machine-learned models, such as selection of multimodal input portions, selection of input portions based on a multimodal query, or other multimodal operation. As a non-limiting illustrative example, an example multimodal machine-learned model can include a vision-language model (e.g., Google Gemini family model, PaliGemma, etc.). For example, in some instances, a computing system can receive a visual question answering (VQA) query comprising a natural language (e.g., English text, etc.) question and one or more images; select one or more multimodal input portions (e.g., VQA K-shot examples each comprising an example question, example image, and corresponding example answer, etc.); and provide a combination of the selected input portions to a multimodal machine-learned model, which can output an answer to the input question. As another example, an example multimodal machine-learned model can include a content recommendation model, wherein a computing system can receive a query (e.g., search query, etc.); select one or more multimodal input portions (e.g., K-shot examples each comprising an example input query, example input content item, and an example output rating associated with the content item) based on the query; and generate, using a multimodal machine-learned model based on a combination of the input portions, an output indicative of a suitability of one or more content items for responding to the query or pairing with one or more other query response items (e.g., search results, etc.).

As another non-limiting illustrative example, in some instances, an example multimodal machine-learned model can include a multimodal vision model (e.g., vision-language model, etc.) configured to automate one or more graphical user interface (GUI) interactions. In some instances, a multimodal model for GUI automation can include a model configured to receive, as input, image data (e.g., screenshot data, etc.) showing a current state of the GUI and query data (e.g., natural language user query, etc.) requesting a GUI interaction; and generate, as output, an action selection output to cause a computing system to perform the requested GUI interaction. For example, a computing system can receive a query requesting one or more GUI automation actions (e.g., actions that may include interaction with one or more GUI elements, such as keyboard inputs, mouse inputs, website interactions, or the like); select one or more multimodal input portions (e.g., K-shot examples each comprising an input query and corresponding output application programming interface (API call), etc.); generate, using a machine-learned model based on a combination of the input portions, an action selection output; and perform an action according to the action selection output.

Systems and methods according to some aspects of the present disclosure can provide a variety of technical effects and benefits, such as improvements to computing technology (e.g., machine learning technology). For example, in some instances, systems and methods according to some aspects of the present disclosure can reduce a computational cost of multi-part (e.g., K-shot, etc.) input optimization compared to some alternative implementations. As another example, in some instances, systems and methods according to some aspects of the present disclosure can provide improved technical performance (e.g., inference accuracy, etc.) at a given computational cost (e.g., testing cost such as exploration budget, etc.) compared to some alternative implementations.

In some instances, systems and methods according to some aspects of the present disclosure can reduce a computational cost of multi-part (e.g., K-shot, etc.) input optimization compared to some alternative implementations. For example, in some instances, systems and methods using a combinatorial selection strategy can reduce a computational cost of testing candidate input combinations compared to some alternative implementations. For example, some non-combinatorial input optimization strategies may have a computational cost (e.g., testing cost of testing input combinations, etc.) that increases exponentially with respect to the size of a pool of candidate input portions (e.g., candidate K-shot examples) and/or with respect to the size of a prompt (e.g., number K of K-shot examples, etc.). In contrast, example combinatorial selection strategies according to some aspects of the present disclosure can have a computational cost that may increase linearly or polynomially with respect to the size of the prompt or pool of candidate input portions, thereby decreasing a cost of prompt optimization compared to some alternative implementations.

As another example, in some instances, systems and methods according to some aspects of the present disclosure can reduce a size of a pool of candidate input portions from which an input combination is selected, thereby reducing a computational cost of input prompt optimization (e.g., testing cost associated with feedback data collection, etc.) compared to some alternative implementations. For example, in instances where a computational cost of input prompt optimization increases (e.g., linearly, polynomially, exponentially, etc.) in proportion to a size of the pool of candidate input portions, reducing a size of the pool of candidate input portions can reduce a computational cost of input prompt optimization (e.g., testing cost associated with feedback data collection, etc.), thereby improving the functioning of the computing system and machine learning technology (e.g., input optimization technology, etc.).

As another example, in some instances, example selection strategies based on an exploration-exploitation tradeoff can reduce a cost (e.g., computational cost, etc.) of input optimization (e.g., testing cost of feedback data collection, etc.) compared to some alternative implementations, or can improve a technical performance (e.g., inference accuracy, etc.) of a machine-learned model prompted with the selected input combinations compared to some alternative implementations. For example, in some instances, some example exploration-exploitation tradeoff strategies described herein can reduce (e.g., minimize, etc.) a loss value (e.g., regret value, etc.) associated with a plurality of machine-learned inference iterations, such as by optimizing an exploration-exploitation tradeoff based on a loss function comparing an estimated value of gaining new feedback data to an estimated value of exploiting already gathered feedback data.

As another example, in some instances, combinatorial selection of one or more hyperparameters (e.g., selection hyperparameters, combination hyperparameters, etc.) can reduce a computational cost of input optimization or improve a technical performance of machine-learned inference operations compared to some alternative implementations. For example, in some instances, combinatorially selecting one or more hyperparameters (e.g., selection hyperparameters, combination hyperparameters, etc.) can reduce a computational cost of testing input combinations compared to some alternative non-combinatorial selection methods (e.g., exhaustive search, etc.) over the same search space. As another example, in some instances, combinatorially selecting one or more hyperparameters (e.g., selection hyperparameters, combination hyperparameters, etc.) can reduce a selection space in which each of a plurality of other selections are made (e.g., reduced pool of candidate input portions, etc.), thereby potentially reducing a computational cost of input optimization (e.g., testing cost associated with feedback data collection, etc.) compared to some alternative implementations. As a non-limiting illustrative example, selecting a selection hyperparameter (e.g., diversity hyperparameter, query similarity hyperparameter, etc.) can reduce a selection space (e.g., to a subset of candidate input portions that satisfy a diversity threshold, query similarity threshold, or the like, etc.) from which one or more input portions of an input combination are selected, thereby potentially reducing, in some instances, a computational cost of input prompt optimization (e.g., testing cost associated with feedback data collection, etc.).

In some instances, systems and methods according to some aspects of the present disclosure can provide improved technical performance (e.g., inference accuracy, etc.) of a machine-learned model compared to some alternative implementations. For example, in some instances, systems and methods that can provide similar (e.g., same, etc.) technical performance at a reduced computational cost can be adapted to provide improved technical performance at similar (e.g., same) computational costs compared to some alternative implementations. For example, in some machine-learning architectures, a technical performance (e.g., inference accuracy, etc.) of a machine-learned model may scale with computational cost in various ways. For example, increasing a number of parameters of some machine-learned models (e.g., neural network models such as transformer models, etc.) can in some instances increase both a computational cost and inference accuracy associated with the machine-learned model. As another example, increasing a “thinking time” (e.g., number of chain-of-thought reasoning cycles or other analysis operations, etc.) of a machine-learned model can in some instances increase both a computational cost and an inference accuracy of a machine-learned inference operation. Thus, in some instances, systems and methods that can provide similar (e.g., same, etc.) technical performance at a reduced computational cost can be adapted (e.g., by increasing a number of model parameters, thinking time, parameter precision, or other metric correlated with inference accuracy and computational complexity) to provide improved technical performance at similar (e.g., same) computational costs compared to some alternative implementations.

Various example implementations are described herein with respect to the accompanying Figures.

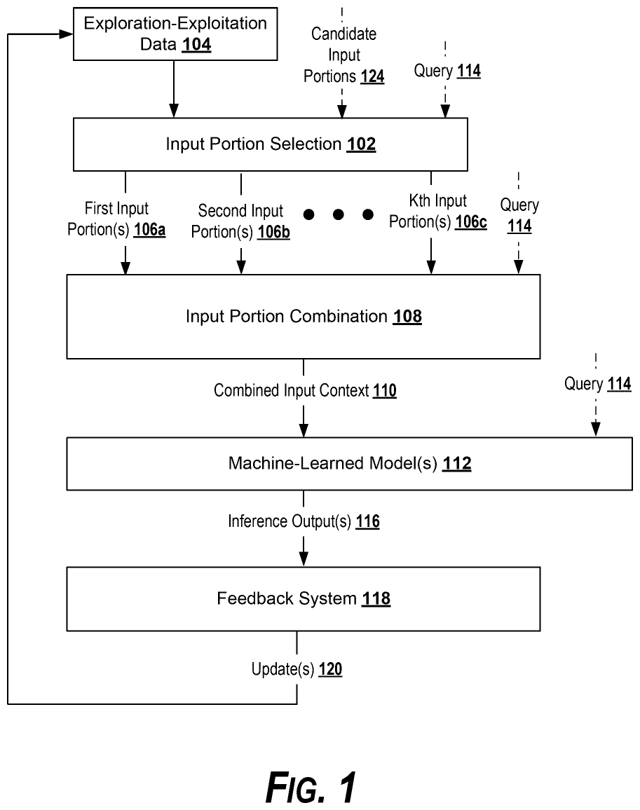

FIG. 1 is a block diagram of an example system for input combination selection according to example implementations of aspects of the present disclosure. An input portion selection system 102 can select (e.g., from a pool of candidate input portions 124, etc.), based at least in part on exploration-exploitation data 104, a plurality of selected input portions 106. In some instances, a selection can be optionally based in part on additional data, such as a query 114 (e.g., user query 114, etc.). An input portion combination system 108 can combine the plurality of selected input portions 106 to generate a combined input context 110, which can be provided to a machine-learned model 112. The machine-learned model 112 can generate, based at least in part on the combined input context 110 and based at least in part on a query 114 (e.g., user query included in or separate from the combined input context 110, etc.), one or more inference outputs 116. A feedback system 118 can obtain (e.g., receive, generate, etc.) feedback data (e.g., rating data, score data, etc.) indicative of a quality (e.g., suitability, goodness, relevance, accuracy, etc.) of the inference output(s) 116, and can provide one or more updates 120 to the exploration-exploitation data 104 based on the feedback data.

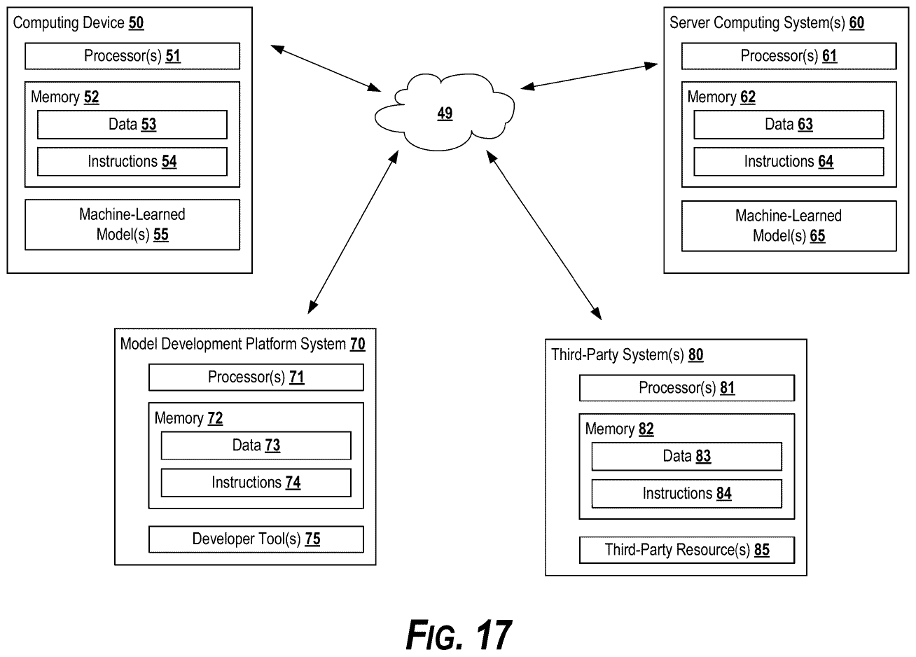

An input portion selection system 102 can be or include one or more software, firmware, or hardware components configured to select a plurality of input portions 106 from a pool of candidate input portions 124. In some instances, the input portion selection system 102 can be, comprise, be comprised by, or share one or more properties with a computing device or system described below with respect to FIGS. 17-19 (e.g., computing device 50, server computing system 60, computing device 98, computing device 99, etc.).

Exploration-exploitation data 104 can generally include or otherwise represent various types of data. Exploration-exploitation data 104 can include one type or many different types of data. Example data types for exploration-exploitation data 104 can include, for example, numerical data (e.g., statistical data, reward data, count data, etc.), identifier data (e.g., numerical identifier, name, input portion identifier(s), function identifier(s), category identifier(s), etc.), data type(s) associated with feedback data (e.g., numerical feedback data, natural language feedback data, categorical or Boolean feedback data, etc.), or other data type.

In some instances, exploration-exploitation data 104 can include reward data. For example, in some instances, exploration-exploitation data 104 can include reward data correlating a plurality of respective candidate input portion(s) 124 to a plurality of corresponding reward value(s) associated with the respective candidate input portion 124. For example, in some instances, exploration-exploitation data 104 can include, for each respective candidate input portion 124 of a plurality of candidate input portions 124, an individualized reward value indicative of feedback data obtained (e.g., received, generated, etc.) for one or more inference outputs 116 generated based on combined input context(s) 110 comprising the respective candidate input portion 124. As another example, in some instances, exploration-exploitation data 104 can include other data correlating respective candidate input portions 124 to corresponding reward values, such as small-group reward data correlating a group of candidate input portions 124 (e.g., group determined randomly, group determined according to a function or formula such as clustering, etc.) to a group reward value indicative of feedback data obtained for inference output(s) 116 generated based on combined input context(s) 110 comprising the group or members thereof; raw feedback data from which individualized or small-group reward values can be computed, such as a data structure (e.g., database table, etc.) comprising a plurality of data entries (e.g., rows, etc.), each entry comprising feedback data and data indicative of one or more candidate input portions 124 associated with the feedback data (e.g., numerical input portion identifiers of candidate input portions 124 used to generate an inference output 116 associated with the feedback data, etc.); or other data correlating respective candidate input portions 124 to corresponding reward values.

In some instances, feedback data can include explicit feedback inputs obtained (e.g., received from a user, from a computing system, from a machine-learned model such as a machine-learned critic or autorater, etc.) in association with an inference output 116, such as a numerical quality rating, a Boolean rating (e.g., “thumbs up” or “thumbs down” button click, etc.), a natural language feedback input (e.g., English-language sentence(s) providing feedback about the inference output 116, etc.) or other feedback data (e.g., numerical rating, etc.) derived from natural language feedback (e.g., numerical feedback rating generated by a sentiment analysis of natural language feedback, such as using a machine-learned sentiment analysis model). In some instances, feedback data can include implicit feedback inputs obtained in associated with an inference output 116, such as data indicative of one or more user behaviors indicative of user satisfaction with the inference output 116 (e.g., follow-up inputs provided by the user, interactions with a link or other data included in the inference output 116, time spent interacting with a website linked to by the inference output 116, time spend viewing or interacting with the inference output 116, etc.).

In some instances, reward values can include reward values obtained (e.g., collected, received, generated, etc.) according to one or more methods depicted herein, such as method(s) depicted herein with respect to FIG. 1. For example, in some instances, obtaining exploration-exploitation data 104 can include initializing the exploration-exploitation data 104 with “empty” (e.g., null, zero-valued, etc.) reward data and one or more initial exploration data values (e.g., initial exploration budget(s), initial parameter value(s) indicative of an exploration-exploitation tradeoff, etc.). In some instances, obtaining exploration-exploitation data 104 can further include selecting (e.g., randomly selecting at a first iteration; selecting based at least in part on reward value data at later iterations; etc.) and combining a plurality of input portions 106, generating an inference output 116 based on the combined input context 110, and performing an update 120 to update reward values of the exploration-exploitation data based on feedback data associated with the inference output 116. Such a process can be repeated, for example, for a plurality of iterations (e.g., indefinitely, such as every time a query 114 is received; until an exploration budget is exhausted; until reward value data is converged, such as until an amount of uncertainty associated with the reward value data is below an uncertainty threshold; etc.).

In some instances, exploration-exploitation data 104 can include data indicative of an amount of uncertainty associated with one or more reward values of the exploration-exploitation data 104. For example, in some instances, data indicative of an amount of uncertainty can include count data (e.g., individualized count data, small-group count data, global count data such as total number of inference outputs 116 for which feedback data has been received, etc.). For example, in some instances, count data can include a plurality of individualized count values for each of a plurality of candidate input portions 124, each individualized count value indicative of a number of feedback data examples obtained in association with the candidate input portion 124, a number of inference outputs 116 generated using the candidate input portion 124, or the like. As another example, in some instances, count data can include other count data values, such as small-group count data or the like. In some instances, data indicative of an amount of uncertainty can include statistical data, such as a standard deviation or variance associated with a plurality of feedback data values (e.g., global standard deviation or variance; individualized or small-group standard deviation or variance; etc.), or other statistical data indicative of an amount of uncertainty.

In some instances, exploration-exploitation data 104 can include exploration parameter data indicative of a degree to which exploration should be prioritized (e.g., indicative of an exploration-exploitation tradeoff, etc.) during each selection operation selecting input portion(s) 106a, 106b, 106c, or the like. In some instances, exploration parameter data indicative of a degree to which exploration should be prioritized can include an exploration budget parameter, such as a number or percentage of input portions 106 that should be randomly selected (e.g., epsilon value of a combinatorial multi-armed bandit selection operation, etc.), a number or percentage of input portions 106 that should be selected according to a process that does not maximize short-term estimated reward values based on the reward data, a number of selection-generation-feedback iterations remaining in an exploration phase of a prompt optimization process, a schedule for gradually decreasing a number or percentage of input portions 106 that should be selected according to a process that does not maximize short-term estimated reward values based on the reward data (e.g., uniform random selection, weighted random selection, etc.), or other exploration budget. In some instances, data indicative of a degree to which exploration should be prioritized can include count data or uncertainty data, such as a global count of a number of inference outputs 116 for which feedback data has been received; one or more individualized (or small-group, etc.) counts of a number of inference outputs 116 for which feedback data has been received for a particular candidate input portion 124 (or small group, etc.); one or more statistical aggregates of a plurality of count values, such as a mean or median individualized count value, a minimum or maximum individualized count value, or other statistical aggregate; one or more individualized, global, or small-group standard deviation or variance values; or other count data or uncertainty data.

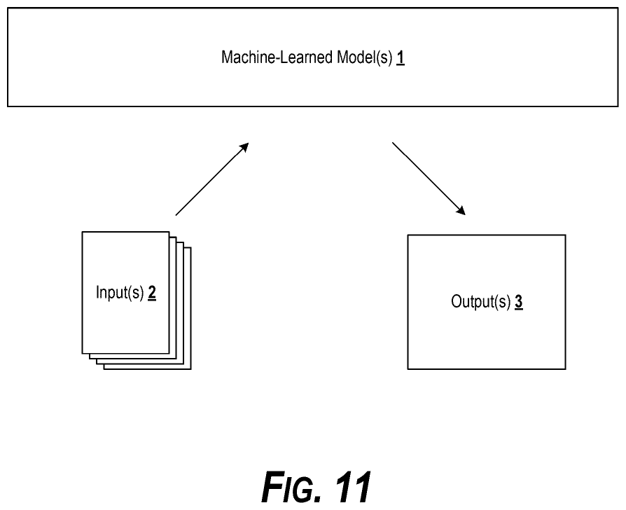

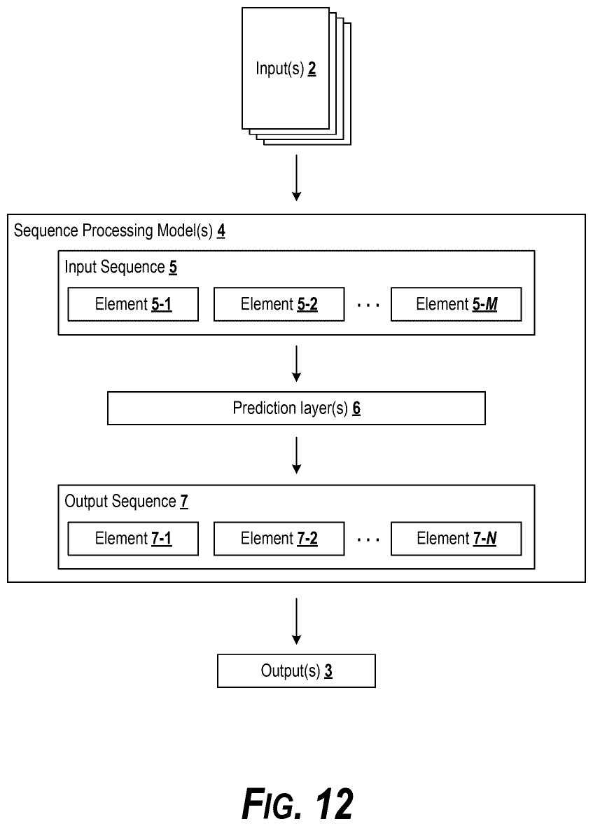

An input portion 106 can generally include or otherwise represent various types of data. An input portion 106 can include one type or many different types of data. An input portion 106 can include one or more data types that are similar to (e.g., same as) or different from one or more data types of exploration-exploitation data 104. Example data types for an input portion 106 can include, for example, any data type described below with respect to FIGS. 11-12 and inputs 2, such as language data (e.g., natural language data such as text or speech data, programming language data, etc.), sequence data (e.g., language sequence, time series, etc.), image data, audio data, video data, or another data type. As a non-limiting illustrative example, in some instances, an input portion 106 can include a multimodal input portion, such as a multimodal input portion comprising language data (e.g., text data, speech data, natural language data such as English, etc.) and one or more other data types, such as image data, video data, or audio data.

In some instances, a selected input portion 106 can include a candidate input portion 124 that has been selected by the input portion selection system 102 (e.g., based on exploration-exploitation data 104, based on a query 114, etc.). In some instances, a plurality of input portions 106 can include a plurality of modular (e.g., self-contained, interchangeable, etc.) input components configured to be combined (e.g., mixed and matched, etc.) with other input portions 106. In some instances, each input portion 106 can include various kinds of in-context learning content, such as instruction content, few-shot example content, chain-of-thought example content, least-to-most prompting content, or other in-context learning content. For example, in some instances, an input portion 106, 124 can include one or more in-context learning examples, such as an example tuple (e.g., example input-output pair; example triple, quadruple, N-tuple, etc.) comprising at least an example input value and a corresponding example output value associated with the example output value. In some instances, an input portion 106, 124 can further include one or more delimiters, such as delimiters identifying one or more components of the input portion 106, 124 (e.g., “Input:”, “Output:”, “Thought:”, “Action:”, <observation>, “{1}”, “(A)”, etc.). In some instances, an example tuple can further include example reasoning content, such as an example reasoning chain comprising a plurality of reasoning steps to arrive at the example output based on the example input. Other input portion 106, 124 types are possible. For example, in some instances, selecting a plurality of input portions 106 can include performing one or more first selections to determine one or more input portions 106 of a first type (e.g., system prompt, retrieved data for retrieval-augmented generation, etc.) and performing one or more (e.g., a plurality of, etc.) second selection operations to determine one or more input portions 106 of one or more second types (e.g., few-shot examples comprising example input-output pairs; chain-of-thought examples comprising example input-reasoning-output tuples; etc.).

In some instances, selecting one or more selected input portions 106 from a pool of candidate input portions 124 can include selecting based at least in part on exploration-exploitation data 104. In some instances, selecting based on exploration-exploitation data 104 can include selecting according to a multi-armed bandit selection strategy, such as a combinatorial multi-armed bandit selection strategy or sparse multi-armed bandit selection strategy (e.g., sparse combinatorial multi-armed bandit selection strategy). In some instances, combinatorial selection (e.g., combinatorial multi-armed bandit selection, etc.) of input portions 106 can include performing a plurality of distinct selection operations, each selection operation selecting one or more input portions 106a, 106b, 106c that are different from other input portions 106a, 106b, 106c selected in other selection operations of the plurality of distinct selection operations. In some instances, multi-armed bandit (MAB) selection (e.g., combinatorial MAB (CMAB), etc.) can include an asymptotically optimal, fully optimal (e.g., based on one or more known or estimated properties of a statistical distribution of reward values, etc.), or approximately optimal MAB selection strategy.

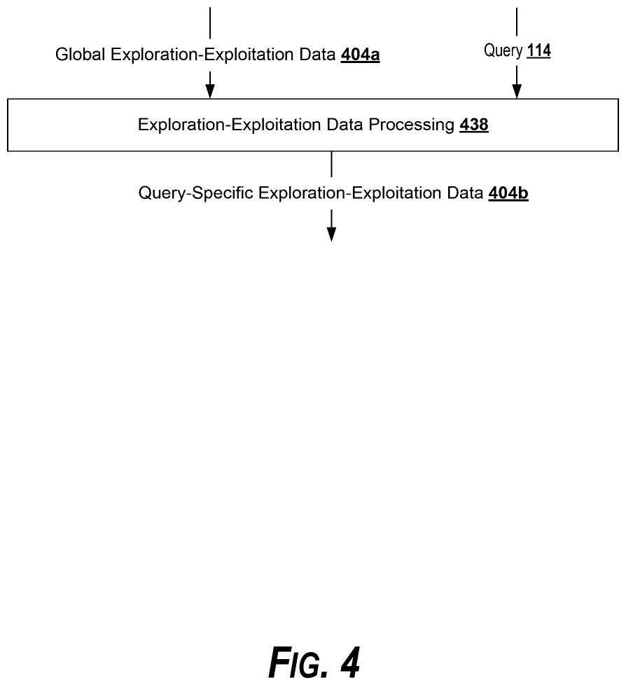

In some instances, MAB (e.g., CMAB) can include an epsilon-based strategy (e.g., epsilon-greedy; epsilon-first; epsilon-decreasing; adaptive epsilon-greedy based on value differences; adaptive epsilon-greedy based on Bayesian ensembles; etc.). An epsilon-based strategy can include, for example, one or more first selection operations comprising an exploitation selection based at least in part on reward values of the exploration-exploitation data 104, such as a selection operation selecting the individual candidate input portion 124 (or small group of candidate input portions 124, etc.) with a highest expected reward value determined based at least in part on past reward value data associated with the individual candidate input portion 124 (or small group, etc.). In some instances, an expected reward value can include a query-independent expected reward value, such as an average reward value for the individual candidate input portion 124 across all queries, or query-dependent expected reward value, such as a weighted average reward value, wherein weights of the weighted average reward value are determined based at least in part on a query 114. Further details of some example methods for determining query-dependent expected reward values are provided below with respect to FIG. 4.

An epsilon-based strategy can further include, for example, one or more second selection operations comprising an exploration selection that does not maximize a short-term expected reward associated with the selection. For example, in some instances, an exploration selection can include random selection (e.g., randomly sampling from a uniform distribution; randomly sampling from a weighted distribution, such as diversity-weighted, uncertainty-weighted, reward-weighted, or the like). As another example, in some instances, an exploration selection can include a selection based at least in part on an amount of uncertainty associated with the selected input portion 106, such as a selection based on a scoring function comprising an uncertainty component and a reward value component; selection based on a probability of a true reward value being greater than a threshold value (e.g., static or adaptive threshold value, such as a true reward value associated with a candidate input portion 124 having a highest short-term estimated reward, etc.) given the current exploration-exploitation data 104.

In some instances, an epsilon-based strategy can include performing, according to a numerical epsilon parameter (e.g., real number between 0 and 1, etc.), a first percentage (e.g., epsilon, etc.) of exploitation selections and a second percentage (e.g., one minus epsilon, etc.) of exploration selections. In some instances, epsilon can be a fixed or variable parameter, such as a parameter that reduces over time (e.g., according to a predetermined schedule, etc.) as more exploration-exploitation data 104 is collected; a parameter that adaptively varies based on data indicative of an amount of a level of certainty of reward value data of the exploration-exploitation data 104 (e.g., a parameter that is proportional or otherwise correlated with uncertainty in estimated reward values, update 120 sizes or fluctuations in the estimated reward values, a parameter updated according to a Bayesian analysis based on a known, estimated, or assumed probability distribution of reward values (e.g., normal distribution, etc.), etc.).

In some instances, a selection operation can include selecting a selected input portion 106 based at least in part on a query 114. For example, in some instances, a selection can be based at least in part on a similarity metric between a query 114 and one or more candidate input portions 124. For example, in some instances, a similarity metric can include a distance metric (e.g., cosine distance, Euclidean distance, etc.) between a machine-learned embedding of a query 114 (e.g., embedding in a first machine-learned embedding space, embedding performed by a first machine-learned model, etc.) and a machine-learned embedding (e.g., embedding vector, etc.) of a candidate input portion 124 (e.g., embedding in the first machine-learned embedding space associated with the query 114 embedding, embedding performed by the first machine-learned model used to embed the query 114, etc.).

In some instances, a selection operation can include a contextual multi-armed bandit selection operation (e.g., linear upper confidence bound, linear associative reinforcement learning, piecewise upper confidence bound, kernelized non-linear upper confidence bound, generalized linear model, random forest, selection based on machine-learned reward value estimates, etc.) based at least in part on the query 114. For example, in some instances, exploration-exploitation data 104 can be processed based at least in part on the query 114 to generate query-specific exploration-exploitation data 104, and a selection can be made based on the query-specific exploration-exploitation data 104 (e.g., according to any method described herein, such as epsilon-based methods, asymptotically or fully optimal methods, etc.). Further details of some example methods for processing exploration-exploitation data 104 based at least in part on the query 114 to generate query-specific exploration-exploitation data 104 are provided below with respect to FIG. 4.

In some instances, a selection operation can include a machine-learned selection operation, such as a selection operation performed using a lightweight machine-learned model having a much lower computational cost of inference compared to the machine-learned model 112. In some instances, a selection operation can include a selection operation configured to reduce (e.g., minimize, nearly minimize, reduce compared to an exploration-only selection strategy such as uniform random selection, reduce compared to an exploitation-only selection strategy such as highest-expected-reward selection, etc.) an expected regret value. A regret value can include, for example, a difference between a maximum total sum of reward values over a plurality of iterations and a sum of actual reward values associated with inference outputs 116 generated over the plurality of iterations. In some instances, a selection operation can include a selection operation using a lightweight machine-learned model trained based on a loss function indicative of a regret value.

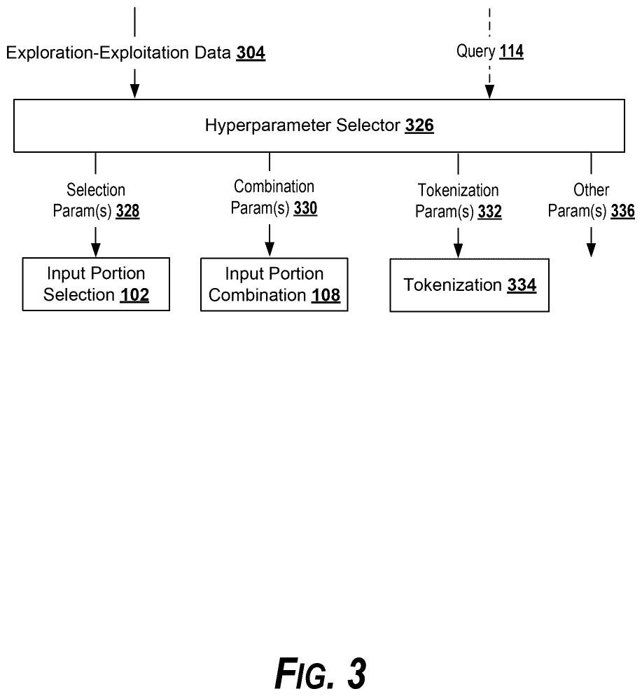

In some instances, a selection operation can include selecting one or more later input portions 106b, 106c based at least in part on a metric of diversity between the later-selected input portions 106b, 106c and already-selected input portions (e.g., first input portion(s) 106a, etc.). For example, in some instances, selecting based on diversity can include selecting based at least in part on a metric of similarity (e.g., metric of distance between embedding values, etc.) between one or more already-selected input portions 106 and one or more candidate input portions 124. In some instances, selecting based on diversity can include ignoring candidate input portions 124 that are too similar (e.g., distance metric below a distance threshold, etc.) to an already-selected input portion 106; weighting a selection scoring function based at least in part on a metric of diversity (e.g., minimum distance to nearest already-selected input portion 106, average distance to plurality of already-selected input portions 106, etc.) associated with a candidate input portion 124; or other diversity-based selection operation. In some instances, selecting based at least in part on a metric of diversity can include selecting at least in part on a diversity hyperparameter, such as a minimum diversity threshold, a diversity weighting value associated with a selection scoring function, or the like. Further details of some example methods for selecting a diversity hyperparameter are described below with respect to FIG. 3. In some instances, selecting based at least in part on diversity can include processing reward value data of the exploration-exploitation data 104 based at least in part on data indicative of an effect of input portion 106 diversity of one or more combined inputs 110 on reward value(s) associated with inference output(s) 116 generated from the combined input(s) 110 to generate a plurality of estimated reward values for each of a plurality of candidate input portions 124, wherein each estimated reward value of the plurality of estimated reward values is based at least in part on a metric of diversity associated with the candidate input portion 124. In some instances, data indicative of an effect of input portion 106 diversity of one or more combined inputs 110 on reward value(s) associated with inference output(s) 116 generated from the combined input(s) 110 can include statistical data (e.g., correlation, covariance, or slope of a diversity-vs-reward-value relationship), data structure comprising data entries (e.g., database table rows, etc.) correlating individual reward values to individual diversity values of individual combined input(s) 110, or other data indicative of a relationship between combined input 110 diversity and feedback values.

In some instances, one or more later-selected input portions 106 (e.g., input portions 106b, 106c, etc.) can be selected based at least in part on both of a query 114 and one or more earlier-selected input portions 106 (e.g., based on a metric of diversity between the earlier-selected input portions 106 and one or more candidate input portions 124). For example, in some instances, a diversity metric can include a relative diversity metric, such as metric of diversity between input portion(s) 106 in relation to a query 114. For example, in some instances, a relative diversity metric can include a metric of diversity of relative embedding values of the input portion(s) 106 in relation to an embedding value of the query 114. For example, a query 114 embedding vector can be subtracted from each of a plurality of input portions 106, 124 to generate a plurality of difference vectors, and one or more later-selected input portions 106 can be selected based on a metric of diversity of the difference vectors. For example, in some instances, a metric of diversity of difference vectors can include a metric determined based on one or more distance metrics (e.g., cosine distance, Euclidean distance, etc.) between a difference vector associated with a candidate input portion 124 and each of one or more already-selected input portions 106, such as a minimum difference metric, average distance metric, or the like. In some instances, a metric of relative diversity can include a metric of angular diversity of difference vector directions or a metric of scalar diversity of difference vector magnitudes. For example, a metric of angular diversity can include a metric of angular distance (e.g., cosine distance, etc.) between a difference vector associated with a candidate input portion 124 and one or more difference vectors associated with one or more already-selected input portions 106, such as a minimum angular difference or the like. As another example, in some instances, a metric of scalar diversity can include a metric comparing a scalar magnitude of a difference vector of a candidate input portion 124 to one or more scalar magnitudes of one or more difference vectors associated with one or more already-selected input portions 106, or to a target distribution of scalar magnitudes. For example, selecting based on a metric of scalar diversity can include selecting based on a scoring function that increases a likelihood of selecting a candidate input portion 124 that cause a distribution of scalar magnitudes of difference vectors to become closer to a target distribution, and decreases a likelihood of selecting a candidate input portion 124 that causes a distribution to become further away from the target distribution.

In some instances, selecting based at least in part on a query 114 can include selecting based at least in part on a category (e.g., predetermined category, human-defined category, etc.) or classification (e.g., machine-learned classification, etc.) associated with the query 114. For example, in some instances, selecting based on a query 114 can include prioritizing candidate input portions 124 associated with a similar (e.g., same) category or classification as a query 114; selecting a target number of input portions 106 of one or more categories or classification(s) based on a category or classification of a query 114; selecting based on a relative diversity metric such as a diversity relative to a statistical distribution of candidate input portions 124 associated with a category or classification of the query 114; or the like.

In some instances, selecting based at least in part on a diversity metric can include selecting based at least in part on a category (e.g., predetermined category, human-defined category, etc.) or classification (e.g., machine-learned classification, etc.) associated with each of one or more input portions 124, 106, etc. For example, in some instances, a metric of diversity can include a metric that prioritizes selection of candidate portions 124 belonging to categories or classification(s) that are unrepresented or underrepresented (e.g., relative to global population values indicative of a percentage of candidate input portions 124 in each category; relative to a general-purpose or query-specific target category distribution or classification distribution; etc.) in a set of already-selected input portions 106, and deprioritizing categories or classifications that are currently overrepresented during a particular selection operation.

An input portion combination system 108 can be or include one or more software, firmware, or hardware components configured to combine selected input portions 106 to generate a combined input context 110. In some instances, the input portion combination system 108 can be, comprise, be comprised by, or share one or more properties with a computing device or system described below with respect to FIGS. 17-19 (e.g., computing device 50, server computing system 60, computing device 98, computing device 99, etc.). In some instances, an input portion combination system 108 can include a computing system that is the same as or different from a computing system associated with the input portion selection system 102.

Combining a plurality of input portions 106 to generate a combined input context 110 can include, for example, one or more combining operations. In some instances, a combining operation can include concatenating two or more selected input portions 106 (e.g., all selected input portions 106; a subset of the selected input portions 106; etc.). In some instances, a combining operation can include embedding each of two or more selected input portions 106 (e.g., processing each input portion 106 with a machine-learned embedding model, a subset of layers of a generative machine-learned model, or the like; etc.) to generate two or more embedding values (e.g., embedding vector in a machine-learned embedding space, etc.), and combining (e.g., pooling such as average pooling, etc.) the embedding values. In some instances, a combining operation can include providing two or more input portions 106 to a machine-learned model and generating, using the machine-learned model, a combination value associated with the two or more input portions 106 (e.g., combined summary of the input portions 106, new input portion generated based on the two or more selected input portions 106, etc.). In some instances, combining a plurality of input portions can include two or more types of combining operations. As a non-limiting illustrative example, generating a combined input vector 110 can include performing one or more first combining operations using a first combining method (e.g., concatenation, machine-learned summarization, etc.) to generate intermediate combined values; and performing one or more second combining operations using a second combining method (e.g., pooling of embedding values, concatenation, etc.) to generate a combined input context 110.

In some instances, combining a plurality of input portions to generate a combined input context 110 can include performing a combining operation (e.g., concatenation, pooling, machine-learned combination, etc.) determined according to a combination hyperparameter. In some instances, a combination hyperparameter can be selected according to a combinatorial multi-armed bandit strategy (e.g., in conjunction with selecting input portions 106; according to a strategy for selecting both hyperparameter(s) and input portions 106; etc.). Further details of some example methods for selecting hyperparameters are provided below with respect to FIG. 3.

A combined input context 110 can generally include or otherwise represent various types of data. A combined input context 110 can include one type or many different types of data. Example data types for a combined input context 110 can include, for example, any data type described below with respect to FIGS. 11-12 and inputs 2, such as language data (e.g., natural language data such as text or speech data, programming language data, etc.), sequence data (e.g., language sequence, time series, etc.), image data, audio data, video data, or another data type. In some instances, a combined input context 110 can include embedding data, such as one or more machine-learned embedding vectors in a machine-learned embedding space. In some instances, a combined input context 110 can include multimodal data, such as language-image multimodal data, embedding data associated with a multimodal machine-learned model or multimodal embedding space, or the like.

The machine-learned model(s) 112 can include one or more machine-learned models. The machine-learned model(s) 112 can include various model architectures, such as various neural network model architectures. An example model architecture for a machine-learned model(s) 112 can include a sequence processing model architecture (e.g., a transformer model). For example, the machine-learned model(s) 112 can be configured to receive an input sequence and generate an output sequence. For instance, the machine-learned model(s) 112 can be configured to generate an output sequence where elements of the output sequence are predicted based on the elements of the input sequence. In some instances, a machine-learned model 112 can include a model architecture having an attention mechanism (e.g., self-attention). In some instances, the machine-learned model 112 can be a pre-trained model (e.g., pretrained using large-scale unsupervised learning). In some instances, the machine-learned model 112 can be fine-tuned over one or more fine-tuning datasets, such as a fine-tuning dataset associated with one or more specialized generation tasks.

In some instances, a machine-learned model 112 can include a multimodal machine-learned model. In some instances, a multimodal machine-learned model 112 can include a multimodal machine-learned model configured to receive, as input, one or more of: text data (e.g., natural language text data, computer code data, structured text data such as JSON-structured text data, etc.), natural language data (e.g., text data, speech data, etc.), image data, audio data (e.g., speech data, music data, etc.), video data, or other input type. In some instances, a multimodal machine-learned model 112 can include a multimodal machine-learned model configured to provide, as output, one or more of: text data (e.g., natural language text data, computer code data, structured text data such as JSON-structured text data, etc.), natural language data (e.g., text data, speech data, etc.), image data, audio data (e.g., speech data, music data, etc.), video data, or other input type. As a non-limiting illustrative example, a multimodal machine-learned model 112 can include a multimodal sequence processing model (e.g., Google Gemini, etc.) configured to receive, as input, one or both of text data and image data; and provide, as output, one or both of text data and input data (e.g., wherein a data type of a generated output can depend at least in part on an input context, etc.).

A query 114 can generally include or otherwise represent various types of data. A query 114 can include one type or many different types of data. A query 114 can include data having a data type that is the same as or different from a data type of a combined input context 110 or input portion 106. Example data types for an query 114 can include, for example, any data type described below with respect to FIGS. 11-12 and inputs 2, such as language data (e.g., natural language data such as text or speech data, programming language data, etc.), sequence data (e.g., language sequence, time series, etc.), image data, audio data, video data, or another data type.

In some instances, a query 114 can be provided to a machine-learned model 112 separately from the combined input context, or as part of (e.g., combined with, etc.) the combined input context 110. For example, in some instances, an input portion combination system 108 can combine the query 114 with the selected input portions 106 (e.g., in any manner described herein with respect to combining the selected input portions 106, etc.) to generate a combined input context 110 comprising or based on the query 114. Other implementations are possible.

An inference output 116 can generally include or otherwise represent various types of data. An inference output 116 can include one type or many different types of data. An inference output 116 can include data having a type that is the same as or different from a data type of the combined input context 110, query 114, or the like. Example data types for an inference output 116 can include, for example, any data type described below with respect to FIGS. 11-12 and inputs 2, such as language data (e.g., natural language data such as text or speech data, programming language data, etc.), sequence data (e.g., language sequence, time series, etc.), image data, audio data, video data, or another data type.

A feedback system 118 can be or include one or more software, firmware, or hardware components configured to obtain feedback data and provide updates 120 to the exploration-exploitation data 104 based on the feedback data. In some instances, the feedback system 118 can be, comprise, be comprised by, or share one or more properties with a computing device or system described below with respect to FIGS. 17-19 (e.g., computing device 50, server computing system 60, computing device 98, computing device 99, etc.). In some instances, a feedback system 118 can be, comprise, or be comprised by a computing system that is the same as or different from a computing system associated with the input portion selection system 102 or input portion combination system 108.

In some instances, obtaining feedback data can include providing an inference output 116 to an entity (e.g., user, computing system, machine-learned model, etc.) and receiving, from the entity, the feedback data. For example, in some instances, an inference output 116 can be provided by the feedback system 118 to a user, and the feedback system 118 can receive, from the user, feedback data such as data indicative of a level of user satisfaction with the inference output 116, data indicative of a correctness of the inference output 116, label or classification data indicative of one or more characteristics (e.g., classifications, categories, properties, etc.) of the inference output 116, or other feedback data. In some instances, obtaining feedback data can include generating feedback data using one or more machine-learned models (e.g., machine-learned critic or automatic evaluator model, machine-learned binary classifier, etc.), such as one or more machine-learned models configured to evaluate a degree to which the inference output 116 satisfies one or more goals (e.g., goals defined by a query 114, query-independent system goals, etc.), a degree to which the inference output 116 has one or more characteristics, or the like. For example, in some instances, an example critic or evaluator model can include an entailment classifier, which can output feedback data indicating whether an inference output 116 is entailed by one or more inputs 110, 114 to the machine-learned model 112. As another example, in some instances, an evaluator model can include a sentiment classifier, politeness classifier, safety classifier, or other alignment classifier indicative of a degree to which an inference output 116 is aligned with one or more goals or preferences of a user, computing services provider, or other entity.

An update 120 can include, for example, any operation for modifying exploration-exploitation data 104 (e.g., based at least in part on feedback data associated with an inference output 116). For example, in some instances, an update 120 can include updating exploration data of the exploration-exploitation data 104, such as an update to one or more count values (e.g., count data indicative of a number of times one or more input portions 106 have been used in a combined input context 110, number of times feedback data has been received, number of inference outputs 116 that have been generated, etc.); an update to an exploration parameter (e.g., epsilon parameter indicative of a number or percentage of input portions 106 to be selected randomly or to be selected in a manner that does not maximize short-term estimated rewards; number of iterations remaining in an exploration budget; etc.); or the like.

In some instances, an update 120 can include updating reward value data of the exploration-exploitation data 104. For example, in some instances, feedback data can be obtained for an inference output 116 generated based on a combined input context 110 associated with a plurality of selected input portions 106; and reward value data (e.g., individualized reward value data, small-group reward value data, etc.) associated with each of the plurality of selected input portions 106 can be updated based on the feedback data. For example, in some instances, feedback data can include a numerical reward value associated with the inference output 116 as a whole, and updating the reward value data can include updating individualized reward value data of each selected input portion 106 used to generate the inference output 116 based at least in part on the numerical reward value. In some instances, updating an individualized reward value can include aggregating (e.g., summing, averaging, weighted aggregation such as weighted averaging, etc.) the current numerical reward value with prior reward value(s) to generate an aggregated reward value (e.g., average reward value, estimated or expected future reward value, etc.) associated with an individual input portion 106 (or small group, etc.). As an example, in some instances, a reward weighting value can be determined for each of one or more selected input portions 106, and individualized reward value data associated with each of the one or more selected input portions 106 can be updated according to the weight (e.g., based on a weighted average determination, etc.). For example, in some instances, a reward weighting value associated with an individual selected input portion 106 can be based on one or more of a similarity metric between the selected input portion 106 and the query 114; a metric of diversity between the selected input portion 106 and other selected input portions 106 (or metric of uniqueness of the selected input portion 106, etc.); data indicative of an importance or weight of the input portion 106 with respect to an inference output 116 generated based on a combined input context 110, such as an ordering of the selected input portions 106 in a concatenated combined input value 110 (e.g., wherein a machine-learned model 112 weights input values based at least in part on an ordering of a sequence of input values, such as a machine-learned model with a linear attention mechanism, attention mechanism having attention values that are monotonically non-increasing or non-decreasing with respect to a sequence ordering, etc.), attention value generated by one or more attention layers of a machine-learned model 112 in association with the input portion 106, or the like; or other reward weighting value.

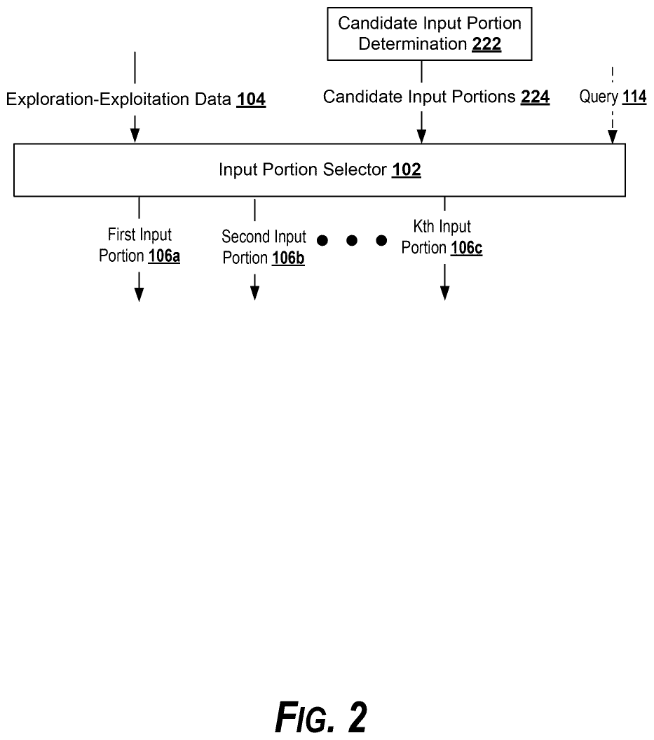

In some instances, a candidate input portion 124 can be, comprise, be comprised by, or otherwise share one or more properties with a selected input portion 106. For example, in some instances, a candidate input portion 124 can have any property described herein with respect to a selected input portion 106, and vice versa. In some instances, a plurality of candidate input portions 124 can include a pool (e.g., set, unchanging pool, query-dependent pool, etc.) of candidate input portions from which the selected input portions 106 are selected at each of a plurality of iterations (e.g., selection-combination-inference-feedback-update iterations as depicted in FIG. 1, etc.). In some instances, a pool of candidate input portions 124 can be or not be a reduced pool of candidate input portions 124 that may be selected or generated from a larger data set. Further details of some example systems and methods for determining a reduced set of candidate input portions 124 from a larger dataset are described below with respect to FIG. 2.

FIG. 2 is a block diagram of an example system for determining a set of candidate input portions for input combination selection according to example implementations of aspects of the present disclosure. A candidate input portion determination system 222 can determine (e.g., select, generate, etc.) a set of candidate input portions 224. An input portion selection system 102 can select, from the set of candidate input portions 224 based at least in part on exploration-exploitation data 104, a plurality of selected input portions 106. In some instances, the selected input portions 106 can be used in a manner described herein with respect to one or more other Figures (e.g., FIG. 1, etc.).

A candidate input portion determination system 222 can be or include one or more software, firmware, or hardware components configured to determine a pool of candidate input portions 224. In some instances, the candidate input portion determination system 222 can be, comprise, be comprised by, or share one or more properties with a computing device or system described below with respect to FIGS. 17-19 (e.g., computing device 50, server computing system 60, computing device 98, computing device 99, etc.). In some instances, a computing device associated with the candidate input portion determination system 222 can be the same as or different from a computing device associated with an input selection system 102, input combination system 108, or feedback system 118.

In some instances, a candidate input portion 224 can be, comprise, be comprised by, or otherwise share one or more properties with a candidate input portion 124. For example, in some instances, a candidate input portion 224 can have any property described herein with respect to a candidate input portion 124, and vice versa.

In some instances, determining a pool of candidate input portions 224 can include selecting the pool of candidate input portions 224 from a larger dataset (e.g., dataset of identified candidate input portions 124, 224; unlabeled dataset; etc.). In some instances, selecting a pool of candidate input portions 224 can include deduplication. Deduplication can include, for example, removal of exact duplicates, near-duplicates, or other redundant data, such as data that is too similar to one or more candidate input portions 224 according to a similarity metric (e.g., distance metric between embedding values; difference metric between images such as absolute pixel difference or other difference metric; difference metric between video frames such as pixel difference, optical flow, or bitrate of a variable-bitrate compression algorithm; etc.). For example, in some instances, deduplication can include embedding each of a plurality of data items (e.g., candidate input portions, etc.) of a dataset; identifying one or more tuples (e.g., pairs, groups of three or more, etc.) of data items having a similarity metric that is higher than a similarity threshold (e.g., difference metric lower than a difference threshold, etc.); and removing one or more data items of the identified tuple(s) (e.g., removing all but one data item of an identified tuple, etc.). In some instances, deduplication can include clustering (e.g., k-means or g-means clustering, etc.) to determine a plurality of clusters, and removing one or more data items of one or more clusters of the plurality of clusters.

In some instances, selecting a pool of candidate input portions 224 can include clustering to determine a plurality of clusters, and performing one or more other operations on one or more clusters of the plurality of clusters. For example, in some instances, a plurality of data items of a cluster can be combined to generate a combined candidate input portion 224. Combination can include, for example, concatenation, machine-learned combination, or other combination method (e.g., pooling of embedding values in instances where input portions 106, 224 may be stored as embedding vectors, etc.). As a non-limiting illustrative example, in some instances, a data item can include a visual question answering data item comprising an image; one or more questions about the image; and one or more answers to the one or more questions. Continuing the example, a plurality of related data items (e.g., data items of a cluster, etc.) can include data items comprising multiple similar (e.g., same, etc.) images or copies of an image, along with similar (e.g., same) or different question(s) and answer(s). Continuing the example, in such instances, a combined candidate input portion 224 can include the image (or one of the similar image(s), such as a randomly selected image or a most central image in an embedding space of a set of similar images, etc.) and a concatenation of a plurality of question-answer pairs associated with the plurality of data items. In some instances, concatenation can include non-machine-learned concatenation. As another example, in some instances, a combined candidate input portion 224 can include the image and a machine-learned set of question-answer pairs. For example, a plurality of question-answer pairs associated with a plurality of data items can be provided to a machine-learned model (e.g., along with an instruction to remove duplicate or redundant question-answer pairs, select the most representative question-answer pair(s), or the like), and the machine-learned model can generate a candidate input portion 224 based on the plurality of data items. As another example, in some instances, a combined candidate input portion 224 can include a candidate input portion 224 comprising one or more elements generated by a machine-learned model, such as a generated image generated based on a combined machine-learned embedding of a plurality of images of the cluster; one or more generated questions based on a combined machine-learned embedding of a plurality of questions of the cluster; or other generated elements.

More generally, in some instances, all or part of each of a plurality of data items (e.g., candidate input portions, etc.) of a larger dataset can be provided to a machine-learned model (e.g., along with an instruction to select, summarize, deduplicate, or otherwise generate a reduced set of candidate input portions), and the machine-learned model can output data indicative of one or more candidate input portions 224 of a smaller (e.g., smaller than the larger dataset, etc.) pool of candidate input portions 224. In some instances, determining a candidate input portion 224 can include generating (e.g., by a machine-learned model, etc.) a candidate input portion 224. For example, in some instances, unlabeled data (e.g., natural language data, image data, multimodal data, etc.) can be provided to a machine-learned model configured (e.g., fine-tuned, prompted with in-context learning content, etc.) to generate candidate input portion(s) 224 based on the unlabeled data. As a non-limiting illustrative example, log data (e.g., chat log, GUI automation or GUI interaction log, etc.) can be provided to a machine-learned model, along with in-context learning content (e.g., instruction content, etc.) configured to cause the machine-learned model to identify relevant content pairs in the unlabeled data (e.g., question-answer pairs for a candidate input portion determination 222 task associated with a visual question answering machine-learned model; GUI interaction-result data (e.g., success/failure result data, screenshot data indicative of a result of a GUI interaction, etc.) pairs or request-GUI interaction-result triples for a candidate input portion determination 222 task associated with a GUI automation model; recommendation-feedback pairs for a content recommendation model; etc.), and the machine-learned model can generate data indicative of the candidate input portions 224 based on the unlabeled data. Other examples are possible.

In some instances, determining a pool of candidate input portions 224 can include a determination based at least in part on a query 114. For example, in some instances, determining a pool of candidate input portions 224 can include filtering a larger dataset of candidate input portions based at least in part on a query 114. Filtering can include, for example, filtering based on a category (e.g., predetermined or human-defined category, etc.), classification (e.g., machine-learned classification, etc.), machine-learned embedding, or other characteristic of the query 114. For example, in some instances, filtering can include prioritizing candidate input portions 224 that share a classification or category with the query 114, or that have an embedding value that is similar to an embedding value of the query 114. In some instances, filtering can include eliminating some or all data items that do not satisfy one or more filter criteria (e.g., category, classification, or embedding similarity criteria, etc.). In some instances, filtering can include selecting a higher percentage (e.g., relative to a dataset-wide percentage, etc.) of candidate input portions 224 that satisfy one or more criteria and a lower percentage of candidate input portions 224 that do not satisfy the one or more criteria. In some instances, determining a pool of candidate input portions 224 can include selecting candidate input portions 224 according to a scoring function, such as a weighted scoring function based on one or more of a category, classification, or embedding similarity of the candidate input portions 224 in relation to a category, classification, or embedding of the query 114.

FIG. 3 is a block diagram of an example system for hyperparameter selection according to example implementations of aspects of the present disclosure. A hyperparameter selection system 326 can select, based at least in part on exploration-exploitation data 304 (and optionally based in part on other data such as, for example, query 114 data), one or more hyperparameters. For example, in some instances, the hyperparameter selection system 326 can select, based at least in part on exploration-exploitation data 304, one or more selection hyperparameters 328 controlling an aspect of an input portion selection 102 operation; one or more combination parameters 330 controlling one or more aspects of an input portion combination 108 operation; one or more tokenization parameters 332 controlling one or more aspects of a tokenization 334 operation; or one or more other parameters 336 (e.g., hyperparameters controlling one or more operations depicted herein with respect to one or more of FIGS. 1-8, etc.).

In some instances, exploration-exploitation data 304 can be, comprise, be comprised by, or otherwise share one or more properties with exploration-exploitation data 104. For example, in some instances, exploration-exploitation data 304 can have any property described herein with respect to exploration-exploitation data 104, and vice versa. In some instances, exploration-exploitation data 304 can include reward value data associated with one or more candidate hyperparameters of a pool of candidate hyperparameters from which selected hyperparameters 328, 330, 332, 336 are selected. For example, in some instances, reward value data associated with one or more candidate hyperparameters (e.g., individualized data, small-group data, etc.) can include any data described herein with respect to FIG. 1 and reward value data associated with one or more candidate input portions 124. Similarly, in some instances, exploration-exploitation data 304 can include exploration data (e.g., exploration parameter(s), exploration budget(s), epsilon parameter(s), count data, etc.) associated with one or more candidate hyperparameters of a pool of candidate hyperparameters from which selected hyperparameters 328, 330, 332, 336 are selected. For example, in some instances, exploration data associated with one or more candidate hyperparameters (e.g., individualized data, small-group data, etc.) can include any data described herein with respect to FIG. 1 and exploration data associated with one or more candidate input portions 124. In some instances, exploration-exploitation data 304 can be initialized or updated in any manner described herein with respect to exploration-exploitation data 104. As a non-limiting illustrative example, in some instances, exploration-exploitation data 304 can include individualized reward value indicative of an average reward value associated with each of a plurality of candidate hyperparameters; exploration data indicative of a degree of uncertainty associated with one or more reward values (e.g., count data, standard deviation or variance data, etc.); exploration data indicative of a degree to which exploration should be prioritized (e.g., count data, exploration parameter such as epsilon parameter, exploration budget, etc.); or other data described herein with respect to FIG. 1 and exploration-exploitation data 104. As another example, in some instances, updating reward value data can include attributing (e.g., on a weighted or unweighted basis, etc.) a reward value associated with an inference output 116 to one or more hyperparameters used to generate the inference output 116. As another example, in some instances, updating exploration data can include updating exploration data (e.g., epsilon exploration parameter, etc.) according to a multi-armed bandit (e.g., combinatorial multi-armed bandit, etc.) operation (e.g., epsilon-based operation or other approximately optimal operation; asymptotically optimal, fully optimal; contextual MAB operation; etc.).

In some instances, exploration data of exploration-exploitation data 304 can include hyperparameter exploration data (e.g., exploration parameter(s), exploration budget(s), epsilon parameter(s), etc.) that are the same as or different from input portion exploration data of exploration-exploitation data 104. Additionally, in some instances, exploration data of exploration-exploitation data 304 can include one exploration parameter or a plurality of separate exploration parameters, exploration budgets, epsilon parameters, or the like. For example, in some instances, input portions 106 can be selected based on one or more first exploration parameters, and one or more hyperparameters 328, 330, 332, 336 can be selected based at least in part on one or more second exploration parameters different from the first exploration parameter(s). As a non-limiting illustrative example, in some instances, selection hyperparameters 328 can be selected based at least in part on a selection hyperparameter exploration budget; combination hyperparameters can be selected based at least in part on a combination hyperparameter exploration budget; tokenization parameters 334 can be selected based at least in part on a tokenization hyperparameter exploration budget; and so on. As a second non-limiting illustrative example, in some instances, input portion(s) 106 may be selected according to a first exploration budget, and one or more hyperparameters 328, 330, 332, 336 can be selected based at least in part on a second exploration budget that prioritizes exploration to a greater or lesser degree than the first exploration budget (e.g., due to differences between input portions and hyperparameters with respect to search space size, uncertainty, convergence speed, or other relevant metric).

In some instances, each of one or more hyperparameters 328, 330, 332, 336 can be selected from a pool of candidate hyperparameters in any manner described herein with respect to selecting one or more input portions 106 from a pool of candidate input portions 124, 224. For example, in some instances, each of one or more hyperparameters 328, 330, 332, 336 can be selected according to one or more multi-armed bandit selection operations (e.g., epsilon-based MAB operation such as epsilon-greedy, epsilon-first, epsilon-decreasing, adaptive epsilon-greedy based on value differences, adaptive epsilon greedy based on Bayesian ensembles, etc.; contextual MAB operation such as linear upper confidence bound, linear associative reinforcement learning, piecewise upper confidence bound, kernelized non-linear upper confidence bound, generalized linear model, random forest, selection based on machine-learned reward value estimates, etc.; or other MAB operation).

In some instances, selection of one or more hyperparameters 328, 330, 332, or 336 can be performed in addition to one or more selection operations described herein with respect to FIG. 1. For example, in some instances, a hyperparameter selector 326 can select (e.g., according to a multi-armed bandit selection strategy, etc.) one or more selection hyperparameters 328, and an input portion selector 102 can select a plurality of input portions 106 based on the selected selection hyperparameters 328. As another example, in some instances, the hyperparameter selector 326 can select one or more combination parameters 330, and the input portion combination system 108 can combine the selected input portions 106 according to the combination parameters 330 to generate a combined input 110. As another example, in some instances, a hyperparameter selector 326 can select one or more tokenization hyperparameters 332, and a tokenization system 334 can tokenize one or more inputs (e.g., query 114, input portion(s) 106, combined input context 110, etc.) to a machine-learned model 112 based on the tokenization hyperparameters 332.

A hyperparameter selection system 326 can be or include one or more software, firmware, or hardware components configured to select one or more hyperparameters 328, 330, 332, 336 (e.g., according to a multi-armed bandit selection strategy). In some instances, the hyperparameter selection system 326 can be, comprise, be comprised by, or share one or more properties with a computing device or system described below with respect to FIGS. 17-19 (e.g., computing device 50, server computing system 60, computing device 98, computing device 99, etc.). In some instances, a computing device associated with the hyperparameter selection system 326 can be the same as or different from a computing device associated with one or more other components 102, 108, 118, 222 described herein.

A tokenization system 334 can be or include one or more software, firmware, or hardware components configured to tokenize one or more input values (e.g., query 114, input portion(s) 106, combined input context 110, etc.) to be provided to one or more machine-learned models (e.g., machine-learned model(s) 112, etc.). In some instances, the tokenization system 334 can be, comprise, be comprised by, or share one or more properties with a computing device or system described below with respect to FIGS. 17-19 (e.g., computing device 50, server computing system 60, computing device 98, computing device 99, etc.). In some instances, a computing device associated with the tokenization system 334 can be the same as or different from a computing device associated with one or more other components 102, 108, 118, 222, 326 described herein.

Selection hyperparameter(s) 328 can include, for example, one or more hyperparameters for controlling a system or process for selecting input portions 106 from a pool of candidate input portions 124. A selection hyperparameter 328 can generally include or otherwise represent various types of data. A selection hyperparameter 328 can include one type or many different types of data. Example data types for a selection hyperparameter 328 can include, for example, numerical data, function data (e.g., computer code data, function identifier data, etc.), categorical data, or other data type. In some instances, an example selection hyperparameter 328 can include an input portion count parameter indicating a number of input portions 106 to be selected. For example, based on an input portion count parameter selected by the hyperparameter selector 326, the input portion selector 102 can select a number of input portions 106 equal to the selected input portion count.

In some instances, an example selection hyperparameter 328 can include a diversity hyperparameter, such as a diversity metric threshold (e.g., threshold minimum Euclidean distance between embeddings of an already-selected input portion 106 and a candidate input portion 124 being evaluated, etc.), a diversity-based modifier parameter (e.g., weighting parameter of a selection scoring function, such as a weighting parameter controlling a weight, in the selection scoring function, of a metric of diversity between a candidate input portion 124 being evaluated and a plurality of already-selected input portions 106), a clustering parameter (e.g., number of clusters of a clustering function, minimum distance between cluster centroids, etc.), or other diversity hyperparameter. A diversity hyperparameter can include, for example, a hyperparameter that controls a degree to which an input portion selector 102 prioritizes selecting candidate input portions 124 that are different from one or more already-selected input portions 106. In some instances, an example selection hyperparameter 328 can include a query similarity hyperparameter that controls a degree to which an input portion selector 102 prioritizes selecting candidate input portions 124 that are similar to a query 114 according to a similarity metric (e.g., cosine distance or Euclidean distance of machine-learned embedding vectors, etc.), such as a similarity metric threshold, a similarity metric weighting parameter, or other query similarity hyperparameter.

A combination hyperparameter 330 can include, for example, one or more parameters controlling a process or system for combining input portions 106 (and, optionally, other data such as one or more queries 114, etc.) to generate a combined input context 110. A combination hyperparameter 330 can generally include or otherwise represent various types of data. A combination hyperparameter 330 can include one type or many different types of data.

Example data types for a combination hyperparameter 330 can include, for example, numerical data, function data (e.g., computer code data, function identifier data, etc.), categorical data, or other data type.

In some instances, a combination hyperparameter 330 can include data indicative of one or more selected methods for combining input portions 106, such as function name data or other string data, function identifier data, computer code data (e.g., application programming interface (API) call, etc.), or other data indicative of selected method(s) for combining input portions 106. In some instances, a plurality of candidate combination methods for combining input portions 106 can include one or more of a concatenation method; a machine-learned combination method; or a method for combining a plurality of machine-learned embedding values of a plurality of input portions 106. For example, in some instances, a machine-learned combination can include providing, to a machine-learned model (e.g., a machine-learned model that is the same as or different from a machine-learned model that generates an inference output 116, etc.), a plurality of input portions 106, and generating, by the machine-learned model, an output based on the input portions (e.g., summary output, deduplicated concatenation output, etc.). In some instances, a method for combining a plurality of machine-learned embedding values can include pooling, such as average pooling or the like.

In some instances, candidate combination method(s) can include one or more multi-part methods, such as a method comprising one or more first operations to combine one or more small groups of selected input portions 106 to generate one or more small-group combinations, and one or more second operations to combine the one or more small-group combinations with one or more other small-group combinations or with input portions 106. As a non-limiting illustrative example, an example candidate combination method can include a method comprising grouping (e.g., clustering, etc.) two or more related (e.g., similar according to an embedding-based similarity metric; having shared content, such as a shared image associated with two or more multimodal input portions 106; etc.) input portions 106; providing the grouped input portions 106 to a machine-learned model; generating, by the machine-learned model, first combination data (e.g., summary data, deduplicated concatenation data, inference output data such as inference output data autoregressively generated from an embedding of the grouped input portions 106, etc.); and combining (e.g., concatenating, etc.) the first combination data with other input portions 106 or other combination data to generate a combined input context 110.

Other example candidate combination methods are possible.

In some instances, a combination hyperparameter 330 can include additional content to be included in the combined input context (e.g., in addition to the selected input portions 106). For example, in some instances, a hyperparameter selector 326 can select (e.g., according to a multi-armed bandit strategy comprising an exploration-exploitation tradeoff, etc.), from a plurality of candidate supplemental context values (e.g., candidate system prompts, candidate preambles to be added to a beginning of a combined input context 110, candidate templates for combining with or modifying the selected input portions 106, etc.), one or more selected supplemental context values to include in the combined input context 110 (e.g., to combine with the selected input portions 106 according to a selection method determined by one or more selection hyperparameters 328, etc.). In some instances, a combination hyperparameter 330 can include a selected formatting hyperparameter defining a format (e.g., ordering, grammar, delimiter(s), structure, etc.) for the selected input portions 106 or combined input context 110, which can be selected from a plurality of candidate formatting hyperparameters. In some instances, a selected combination hyperparameter 330 can include a selected template hyperparameter defining a template to be combined with one or more input portions 106 (e.g., each selected input portion 106, etc.), such as a fill-in-the-blank template comprising one or more blanks to be filled in using data from a selected input portion 106. A template hyperparameter 330 can be selected, for example, from a plurality of candidate template hyperparameters 330.

In some instances, a selected combination hyperparameter 330 can include a parameter (e.g., method, scoring function, etc.) controlling an order in which the input portions 106 are combined (e.g., concatenated, etc.). For example, in some instances, a function for determining an ordering for combining the selected input portions 106 (e.g., ordering in a combined input context 110 generated by concatenation, etc.) can be selected from a plurality of candidate functions for determining the ordering. In some instances, a candidate function can include a scoring function (e.g., weighted scoring function) for generating a score for each of the plurality of selected input portions 106, and the input portion combination system 108 can combine the selected input portions 106 in an ordering defined by the generated scores (e.g., highest first, lowest first, etc.). In some instances, a candidate scoring function can be based at least in part on (e.g., be based on a weighted combination comprising, etc.) one or more of a metric of similarity (e.g., distance metric in an embedding space, etc.) between a selected input portion 106 and a query 114; a metric of similarity or difference between the selected input portion 106 and one or more other selected input portions 106 (e.g., potential neighboring input portions 106; statistical aggregate over a plurality of other selected input portions 106, such as a minimum difference or average difference metric between the selected input portion 106 and all other selected input portions 106, etc.); a length of the selected input portion; exploration-exploitation data 104 (e.g., reward value data, etc.) associated with the selected input portion 106; or other relevant data.

A tokenization hyperparameter 332 can include, for example, one or more parameters controlling a process or system for tokenizing one or more of a query 114, input portion(s) 106, a combined input context 110, or other values to be tokenized. A tokenization hyperparameter 332 can generally include or otherwise represent various types of data. A tokenization hyperparameter 332 can include one type or many different types of data. Example data types for a tokenization hyperparameter 332 can include, for example, numerical data, function data (e.g., computer code data, function identifier data, function name data, etc.), categorical data, or other data type.

FIG. 4 is a block diagram of a portion of an example system for query-specific input combination selection according to example implementations of aspects of the present disclosure. An exploration-exploitation data processing system 438 can determine, based at least in part on global exploration-exploitation data 404a and based at least in part on a query 114, query-specific exploration-exploitation data 404b. In some instances, the query-specific exploration-exploitation data 404b can be used in one or more operations described herein with respect to exploration-exploitation data 104, such as operations described herein with respect to one or more of FIGS. 1-3 and 5.

An exploration-exploitation data processing system 438 can be or include one or more software, firmware, or hardware components configured to determine (e.g., generate, etc.) query-specific exploration-exploitation data 404b based at least in part on non-query-specific (e.g., global, etc.) exploration-exploitation data 404a and one or more queries 114. In some instances, the exploration-exploitation data processing system 438 can be, comprise, be comprised by, or share one or more properties with a computing device or system described below with respect to FIGS. 17-19 (e.g., computing device 50, server computing system 60, computing device 98, computing device 99, etc.). In some instances, a computing device associated with an exploration-exploitation data processing system 438 can be the same as or different from a computing device associated with an input portion selection system 102, input portion combination system 108, feedback system 118, or the like.

In some instances, global exploration-exploitation data 404a can be, comprise, be comprised by, or otherwise share one or more properties with exploration-exploitation data 104. For example, in some instances, global exploration-exploitation data 404a can have any property described herein with respect to a exploration-exploitation data 104, and vice versa. In some instances, global exploration-exploitation data 404a can include data that has not undergone query-specific filtering, weighting, transformation, or other query-specific processing. For example, in some instances, global exploration-exploitation data 404a can include all exploration-exploitation data 104, 404 (e.g., reward value data, exploration budget data, etc.) that has been collected over a plurality of selection-combination-feedback-update iterations; all exploration-exploitation data 104, 404 associated with a wide embedding space; all exploration-exploitation data 104, 404 of an available dataset; or the like. In some instances, global exploration-exploitation data 404a can include processed data, such as individualized reward value data that has been processed on an input-portion—124—specific basis; raw data, such as a data structure (e.g., database, table, file, object, struct, folder, etc.) comprising a plurality of data entries (e.g., rows, fields, etc.) each comprising feedback data associated with an individual inference output 116 and data indicative of a plurality of input portions 106 or hyperparameters 328, 330, 332, 336 used to generate the inference output 116; or both raw and processed data.

In some instances, query-specific exploration-exploitation data 404b can be, comprise, be comprised by, or otherwise share one or more properties with exploration-exploitation data 104. For example, in some instances, query-specific exploration-exploitation data 404b can have any property described herein with respect to exploration-exploitation data 104, and vice versa. In some instances, query-specific exploration-exploitation data 404b can include query-specific data that has been processed based on a query 114, such as expected reward value data indicative of a query-specific expected reward value associated with one or more candidate input portions 124; weighted or filtered reward value data generated by weighting or filtering raw reward value data based on a query 114; query-specific (e.g., weighted, filtered, etc.) exploration data indicative of a degree to which exploration should be prioritized, such as query-specific uncertainty data (e.g., count data or weighted count data indicative of a number of similar queries 114 for which inference outputs 116 have been generated and feedback received, etc.); or other query-specific exploration-exploitation data 104, 404.

In some instances, generating query-specific exploration data 404b can include weighting one or more values (e.g., reward values; exploration data values such as counts, uncertainty values, etc.) of the global exploration-exploitation data 404a based on the query 114. For example, in some instances, the global exploration-exploitation data 404a can include a plurality of data entries correlating a respective reward value to a respective past query 114 associated with the reward value. Continuing the example, in some instances, generating query-specific exploration data 404b can include weighting one or more respective reward values based on a comparison (e.g., based on a metric of similarity, etc.) between a current query 114 and one or more respective past queries associated with the respective reward values. Continuing the example, in some instances, a query-specific individualized reward value for an individual candidate input portion 124 can be generated based on the weighted reward value data (e.g., by aggregating a plurality of weighted reward values associated with inference outputs 116 generated using the candidate input portion 124). As another example, in some instances, generating query-specific exploration data 404b can include weighting one or more respective individualized reward values associated with one or more respective candidate input portions 124 based on a metric of similarity between the query 114 and each respective input portion 124. In some instances, a metric of similarity can include a metric of distance (e.g., Euclidean distance, cosine distance, etc.) between embeddings (e.g., between embeddings of a current query 114 and a past query 114; between an embedding of a current query 114 and an embedding associated with a candidate input portions 124, such as an embedding of a query component of a candidate input portion 124 comprising a query-response tuple, etc.) in a machine-learned embedding space. In some instances, weighting reward value data can include weighting based on a category or classification associated with the query 114. For example, in some instances, reward value data having a category or classification that is similar to (e.g., same as, etc.) a category or classification of the query 114 can be weighted more heavily in the query-specific exploration-exploitation data 404b compared to reward value data having a category or classification that is different from (e.g., not identical to; more different than a predetermined threshold according to a distance metric; etc.) a category or classification of the query 114.

In some instances, a classification can include a machine-learned classification output, such as an output of a machine-learned binary classifier or other classifier. Example machine-learned classifiers can include, but are not limited to, sentiment classifiers, topic classifiers, task classifiers, risk classifiers (e.g., quality control risk classifiers, cybersecurity risk classifiers, artificial intelligence (AI) alignment risk classifiers, etc.), or other classifier type. In some instances, a category can include any data for grouping one or more first pluralities of queries 114 into one or more first categories and one or more second pluralities of queries 114 into one or more second categories. Example category types can include topic categories; categories associated with a query origin such as a website from which a query 114 was received; categories associated with a user who provided the query 114, such as user group membership categories (e.g., access control list categories or other permissions data, user subscription categories, organizational membership categories such as employer organization categories, etc.) or other user data (e.g., preference data, settings data, account usage data, etc.); or other categories.

In some instances, generating query-specific exploration data 404b can include filtering one or more values (e.g., reward values; exploration data values such as counts, uncertainty values; etc.) of the global exploration-exploitation data 404a based on the query 114. For example, in some instances, filtering can include filtering based on a metric of similarity between the query 114 and one or more other values, such as values associated with past queries 114 or candidate input portions 124. For example, in some instances, a metric of similarity associated with each of a plurality of values (e.g., reward values of the global exploration-exploitation data 404a, etc.) can be compared to a similarity threshold (e.g., threshold Euclidean distance, threshold cosine distance, etc.). Continuing the example, data that satisfies the similarity threshold (e.g., is more similar to the query than the threshold, etc.) can be included in the query-specific exploration-exploitation data 404b, and data that does not satisfy the similarity threshold (e.g., is less similar to the query than the threshold, etc.) can be excluded from the query-specific exploration-exploitation data 404b. For example, in some instances, a plurality of data entries correlating past queries 114 with reward value data associated with inference outputs 116 generated based on the past queries 114 can be filtered based on a metric of similarity between a current query 114 and the past queries 114. Other examples are possible.

In some instances, generating query-specific exploration-exploitation data 404b can include filtering global exploration-exploitation data 404a based on category or classification data associated with a current query 114. For example, in some instances, global exploration-exploitation data 404a entries (e.g., data entries correlating past queries 114 to reward values associated with inference outputs 116 generated from the queries 114, etc.) that share one or more categories or classifications with a current query 114 (e.g., data entries associated with a past query 114 having the same category or classification; data entries associated with a candidate input portion 124 associated with a category or classification of the current query 114; etc.) can be included in the query-specific exploration-exploitation data 404b, and some or all data entries of the global exploration-exploitation data 404a that do not share a category or classification with the current query 114 can be excluded from the query-specific exploration-exploitation data 404b.

In some instances, generating query-specific exploration-exploitation data 404b can include filtering or weighting based on one or more outputs of a machine-learned model. For example, in some instances, data indicative of the query 114 and data indicative of the exploration-exploitation data 404a can be provided to a machine-learned model (e.g., a model that is the same as or different from the machine-learned model 112; a lightweight model configured to generate filtering outputs, such as a lightweight similarity classifier or relevance classifier configured to identify exploration-exploitation data entries that are relevant to the query 114; lightweight model having significantly fewer parameters or significantly lower computational cost compared to the machine-learned model 112, such as ten times lower, 100 times lower, etc.; etc.), and the machine-learned model can generate one or more filtering outputs (e.g., selection outputs selecting data to be included in the query-specific exploration-exploitation data 404b, etc.). Other filtering and weighting methods are possible.

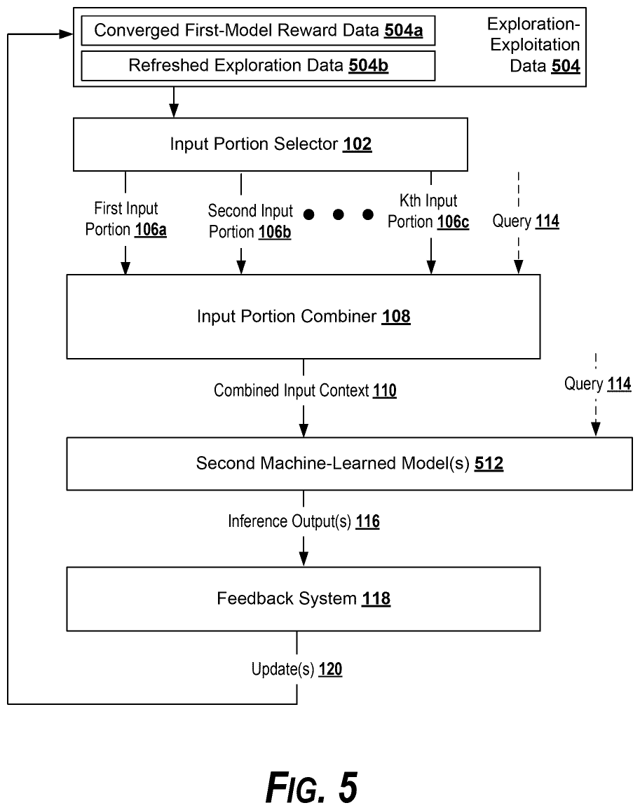

FIG. 5 is a block diagram of an example system for input combination selection for a second machine-learned model based on data associated with a first machine-learned model according to example implementations of aspects of the present disclosure. An input portion selection system 102 can select, based at least in part on exploration-exploitation data 504 (e.g., alone or in combination with other data such as query 114 data, etc.), a plurality of selected input portions 106. In some instances, the exploration-exploitation data 504 can include converged first-model reward data 504a that has been collected in association with a first machine-learned model (e.g., machine-learned model 112, etc.). In some instances, the exploration-exploitation data 504 can include refreshed exploration data 504b associated with a second machine-learned model 512. In some instances, a selection can be optionally based on other data, such as a query 114 (e.g., user query 114, etc.). An input portion combination system 108 can combine the plurality of selected input portions 106 to generate a combined input context 110, which can be provided to the second machine-learned model 512. The second machine-learned model 512 can generate, based at least in part on the combined input context 110 and based at least in part on a query 114 (e.g., user query included in or separate from the combined input context 110, etc.), one or more inference outputs 116. A feedback system 118 can obtain (e.g., receive, generate, etc.) feedback data indicative of a quality (e.g., suitability, goodness, relevance, accuracy, etc.) of the inference output(s) 116, and can provide one or more updates 120 to the exploration-exploitation data 504 based on the feedback data.

In some instances, exploration-exploitation data 504 can be, comprise, be comprised by, or otherwise share one or more properties with exploration-exploitation data 104. For example, in some instances, exploration-exploitation data 504 can have any property described herein with respect to exploration-exploitation data 104, and vice versa. In some instances, exploration-exploitation data 504 can include converged first-model reward data 504a and refreshed exploration data 504b. Converged first-model reward data 504a can include, for example, reward data (e.g., reward data described herein with respect to exploration-exploitation data 104, 304, 404, etc.) that has been determined using a first machine-learned model 112, such as reward data determined using a plurality of selection-combination-inference-update iterations using the first machine-learned model 112. For example, a plurality of iterations can be performed using the first machine-learned model 112, wherein each iteration of the plurality of iterations comprises updating reward value data of exploration-exploitation data 104 and updating exploration data of the exploration-exploitation data 104. Continuing the example, the updated reward value data of the exploration-exploitation data 104 associated with the first machine-learned model can be included in an initial state of exploration-exploitation data 504 associated with the second machine-learned model 512. Continuing the example, in some instances, the updated exploration data can be discarded or not included in the exploration-exploitation data 504, and the refreshed exploration data 504b can include new exploration data, such as exploration data indicating that no reward value data has yet been collected for the second machine-learned model 512; data indicative of a refreshed exploration budget (e.g., exploration budget that is the same as or different from an initial exploration budget used with respect to a first machine-learned model) for optimizing prompts for the second machine-learned model; or the like. In this manner, for instance, prompt optimization reward values associated with a first machine-learned model 112 can provide a starting point for a multi-armed bandit selection process associated with the second machine-learned model 512, and a plurality of iterations can be performed to explore an input portion selection space with respect to the second machine-learned model 512 (e.g., according to a combinatorial multi-armed bandit strategy; according to an exploration-exploitation tradeoff based on the refreshed exploration data 504b; etc.).

In some instances, a second machine-learned model 512 can be, comprise, be comprised by, or otherwise share one or more properties with a machine-learned model 112. For example, in some instances, a second machine-learned model 512 can have any property described herein with respect to a machine-learned model 112, and vice versa.

In some instances, one or more operations depicted with respect to FIG. 5 can be performed in any manner described herein with respect to one or more other Figures, such as FIG. 1.

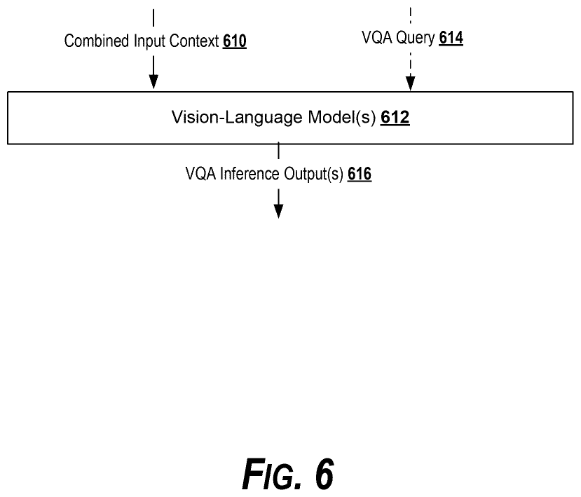

FIG. 6 is a block diagram of an example system for visual question answering according to example implementations of aspects of the present disclosure. A vision-language model 612 can generate, based at least in part on a combined input context 610 and based at least in part on a visual question answering (VQA) query 614, a VQA inference output 616.

In some instances, one or more of a combined input context 610, vision-language model 612, VQA query 614, or VQA inference output 116 can be, comprise, be comprised by, or otherwise share one or more properties with one or more of a combined input context 110, machine-learned model 112, query 114, or inference output 116, respectively. For example, in some instances, a combined input context 610, vision-language model 612, VQA query 614, or VQA inference output 116 can have any property described herein with respect to a combined input context 110, machine-learned model 112, query 114, or inference output 116, and vice versa.

One or more of a combined input context 610 and a VQA query 114 can include multimodal data, such as multimodal data comprising image data and language data (e.g., natural language data such as natural language speech audio, natural language text, etc.). For example, in some instances, a VQA 614 query can include one or more images; natural language data comprising one or more questions about the one or more images; and, optionally, other data (e.g., image caption data, video or audio data, system prompt data, etc.). As another example, in some instances, one or more input portions 106 of a combined input context 610 can include an input-output tuple (e.g., input-output pair, input-reasoning-output tuple, etc.) comprising one or more images; one or more questions associated with the one or more images; and one or more answers (e.g., ground truth answers, etc.) associated with the one or more questions.

In some instances, a vision-language model 612 can include a multimodal configured to receive a multimodal input context comprising at least a visual component (e.g., image component, video component, etc.) and a language component (e.g., text, etc.) and to generate outputs (e.g., language outputs, text outputs, multimodal outputs, etc.) based on the multimodal input context. For example, in some instances, a vision-language model 512 can include a model configured to receive one or more images and one or more questions (e.g., audio questions, text questions, etc.) about the one or more images and to output an answer (e.g., audio answer, text answer, etc.) to the one or more questions. In some instances, a vision-language model 512 can include a model that has been fine-tuned on one or more VQA tasks, or a model that has not been fine-tuned for VQA.

An inference output 616 can include, for example, an inference output 116 comprising an answer (e.g., text answer, audio answer, etc.) to one or more questions included in the VQA query 614.

In some instances, systems and methods depicted herein with respect to FIG. 6 can be combined with component(s) described with respect to other Figures, such as FIG. 1. For example, in some instances, a combined input context 610 can be determined in any manner described herein with respect to FIG. 1 and combined input context(s) 110, and a VQA inference output 616 can be used in any manner described herein with respect to FIG. 1 and inference output(s) 116.

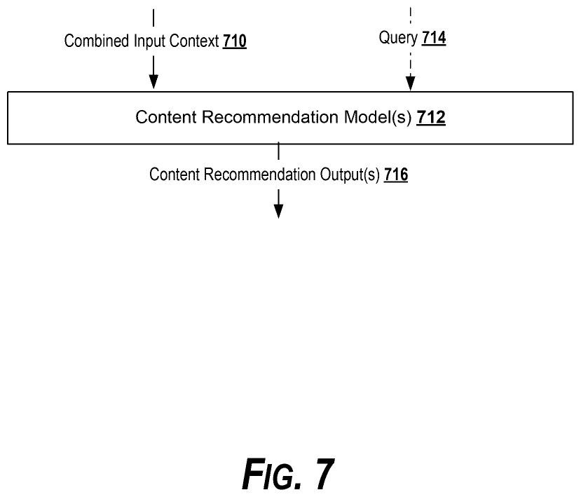

FIG. 7 is a block diagram of an example system for content recommendation according to example implementations of aspects of the present disclosure. A content recommendation model 712 can generate, based at least in part on a combined input context 710 and based at least in part on one or more queries 714, one or more content recommendation outputs 716.

In some instances, one or more of a combined input context 710, content recommendation model 712, query 714, or content recommendation output 716 can be, comprise, be comprised by, or otherwise share one or more properties with one or more of a combined input context 110, machine-learned model 112, query 114, or inference output 116, respectively. For example, in some instances, a combined input context 710, content recommendation model 712, query 714, or content recommendation output 716 can have any property described herein with respect to a combined input context 110, machine-learned model 112, query 114, or inference output 116, and vice versa.

In some instances, a content recommendation model 712 can include a multimodal model, such as a vision-language model configured to receive input comprising one or more visual components (e.g., image components, video components, etc.) and one or more language components (e.g., text, audio, etc.). In some instances, a content recommendation model can include a model that has been fine-tuned (e.g., after a pre-training phase or based on a pretrained foundation model, etc.) on a content recommendation task, such as based on a dataset correlating input contexts to corresponding content recommendation values (e.g., content ratings, content selections, etc.; ground truth content recommendation values, feedback data, etc.).

In some instances, a query 714 can include data indicative of a user query or other user input, such as a search query, a query directed to a machine-learned model, a language input (e.g., social media post content, etc.), or other input (e.g., GUI interaction input, etc.). In some instances, a query 714 can include data indicative of first content (e.g., search result content, video content, social media content, podcast content, AI content, etc.) to be paired with one or more second content items(e.g., informative or persuasive content items, sponsored content items, etc.), wherein the content recommendation output(s) 716 are associated with the second content items. As a non-limiting illustrative example, in some instances, a query 714 can include data indicative of one or more search results (e.g., web search results, etc.) and data indicative of one or more candidate second content items to be evaluated. In such instances, the content recommendation model(s) 712 can generate one or more content recommendation output(s) 716 indicative of a suitability of the second content item(s) for pairing with the search results. Other examples are possible.

In some instances, a content recommendation output 716 can include an evaluation of candidate content, such as a numerical rating indicative of a suitability of the candidate content (e.g., relevance for responding to a query, suitability for pairing with one or more first content items such as search results, etc.). In some instances, a content recommendation output 716 can include data indicative of one or more recommended content items, such as an identifier (e.g., numerical identifier, uniform resource locator (URL) identifier, etc.) of a recommended content item of a plurality of candidate content items; other data (e.g., natural language data, etc.) identifying a recommended content item or evaluating a candidate content item; data comprising a recommended content item generated by the content recommendation model 712 (e.g., fully or partially AI-generated informative or persuasive content item, etc.); etc. For example, in some instances, a query 714 can include one or more content item templates, and a content recommendation output 716 can include data indicative of a recommended content item generated from the one or more content item templates. As another example, in some instances, a content recommendation output 716 can include one or more numerical evaluation values (e.g., relevance value such as data indicative of a similarity between a user search query and a candidate content item; alignment value or risk value such as data indicative of a risk of undesirable content pairings, etc.), and one or more selected content items can be selected from a plurality of content items based at least in part on the numerical evaluation values. For example, in some instances, one or more highest-rated content items of a plurality of candidate content items can be selected (e.g., for providing to a user, etc.).

In some instances, systems and methods depicted herein with respect to FIG. 7 can be combined with systems or methods described herein with respect to other Figures, such as FIG. 1. For example, in some instances, a combined input context 710 can be determined in any manner described herein with respect to FIG. 1 and combined input context(s) 110, and a content recommendation output 716 can be used in any manner described herein with respect to FIG. 1 and inference output(s) 116.

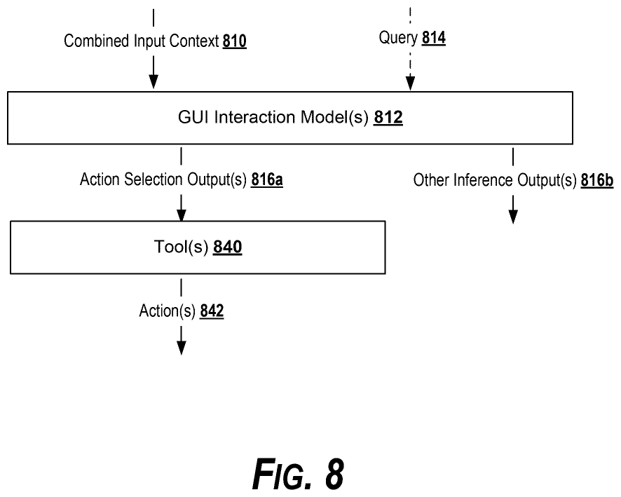

FIG. 8 is a block diagram of an example system for graphical user interface (GUI) automation according to example implementations of aspects of the present disclosure.

One or more GUI interaction models 812 can generate, based at least in part on a combined input context 810 and a query 814, one or more action selection outputs 816a or other inference outputs 816b. In some instances, the action selection output(s) 816a can be provided to one or more tools 840, which can perform action(s) 842 according to the action selection output(s) 816a.

In some instances, one or more of a combined input context 810, GUI interaction model 812, query 814, action selection output 816a, or other inference output 816b can be, comprise, be comprised by, or otherwise share one or more properties with one or more of a combined input context 110, machine-learned model 112, query 114, or inference output 116, respectively. For example, in some instances, a combined input context 810, GUI interaction model 812, query 814, action selection output 816a, or other inference output 816b can have any property described herein with respect to a combined input context 110, machine-learned model 112, query 114, or inference output 116, and vice versa.

In some instances, a GUI interaction model 812 can include a unimodal or multimodal machine-learned model, such as a multimodal vision-language model configured to receive input context comprising one or more of visual data (e.g., screenshot data indicative of a state of a graphical user interface (GUI), etc.) and language data (e.g., natural language speech or text data indicative of a requested GUI action, etc.), and generate one of more inference outputs 116 (e.g., action selection outputs 816a, etc.) based on the input context. In some instances, a GUI interaction model 812 can include a machine-learned agent configured (e.g., fine-tuned, prompted using in-context learning data, etc.) for tool use (e.g., API tool use, GUI tool use, etc.). In some instances, a GUI interaction model 812 can include a machine-learned agent configured (e.g., fine-tuned, etc.) for GUI automation.

In some instances, a GUI interaction model 812 can include a machine-learned model configured to select an action from an action space. In some instances, the GUI interaction model 812 can include a machine-learned model that has been provided with data indicative of the action space. For example, in some instances, data indicative of the action space can be included in the combined input context 810 or query 814, and the GUI interaction model 812 can select one or more actions based on the combined input context 810 and query 814 using in-context learning. As another example, in some instances, the GUI interaction model 812 can include a machine-learned model that has been trained (e.g., pretrained, fine-tuned, etc.) using data indicative of the action space. In some instances, data indicative of the action space (e.g., data provided via an input context, etc.) can include data associated with one or more tools 840, such as data describing a manner of invoking one or more tools 840, data listing a plurality of actions that can be performed by one or more tools 840, or other data.

In some instances, data indicative of the action space (e.g., training data, data provided via an input context, etc.) can include one or more input-output tuples, such as tuples comprising an input context (e.g., user input describing a task to be performed) and a corresponding output value indicative of an action selection (e.g., action name or action identifier associated with the action selection; output sequence such as computer code, pseudocode, function call, application programming interface (API) call, or the like; or other action selection output). For example, in some instances, a plurality of candidate input portions 124 for use with a GUI interaction model 812 can include a plurality of example input-output tuples (e.g., input-output pairs, input-reasoning-output tuples, etc.) indicative of an action space from which an action is to be selected.

In some instances, a candidate input portion 124 can include one or more of a chain-of-thought input portion (e.g., thought-observation-action input portion, etc.), least-to-most input portion, self-critique input portion, or the like. For example, in some instances, an example candidate input portion 124 associated with a GUI interaction model 812 can include an example input indicative of a task to be performed, and an example thought process for performing the example task. In some instances, an example thought process can include a plurality of delimiters configured to mark each part of the example thought process (e.g., “[Thought],” “[Act],” “[Observe]”; “input:”, “tool choice:”, “tool instruction:”; “1” “2” “3”; etc.). An example thought process can include, for example, one or more planning components; one or more action selection output 816a components; one or more action result components; and one or more other inference output 816b components.

In some instances, an example chain-of-thought input portion can include an action selection component comprising an instruction for using one or more tools (e.g., “[Act]: search=‘Paris’”; search(Paris); etc.). In some instances, an example instruction can be in a structured or standardized format, such as a structured or standardized format associated with an action space associated with one or more action selection outputs 816a. In some instances, a structured or standardized format can include a format (e.g., syntax, etc.) associated with a computer coding language (e.g., Python, C, etc.); a format associated with an application programming interface (API), a structure associated with a markup language or object notation language (e.g., extensible Markup Language (XML), JavaScript Object Notation (JSON), etc.), a structure associated with a pseudocode or interpretable instruction set (e.g., pseudocode or action selection output 816a format to be interpreted by glue code associated with the GUI interaction model 812, etc.), or other structure (e.g., comma-separated value, etc.).

In some instances, a query 814 can include a multimodal query 814, such as a multimodal input context comprising one or more of visual data (e.g., visual data indicative of a state of a graphical user interface (GUI), such as screenshot data, etc.) and language data (e.g., natural language speech or text data indicative of one or more requested GUI actions, etc.). In some instances, a query 814 can include a GUI automation request, such as a request to perform an action sequence comprising one or more GUI interactions.

In some instances, one or more input portions 106 of a combined input context 810 can each include multimodal input(s) such as an input-output tuple (e.g., input-output pair, input-reasoning-output tuple, input-action chain-final output tuple comprising one or more action selection outputs and a final output responsive to the input, etc.) comprising an input component comprising one or more of visual data (e.g., screenshot data indicative of a state of a graphical user interface (GUI), etc.) and language data (e.g., natural language speech or text data indicative of a requested GUI action, etc.) and an output component comprising one or more example outputs (e.g., action selection output(s) 816a, other output(s) 816b, etc.) associated with the input component.

In some instances, an action selection output 816a can include computer code that, when executed, causes one or more tools 840 to perform the selected actions, such as one or more API calls associated with an API of a tool 840; computer-executable network requests (e.g., hypertext transfer protocol requests, etc.); or other computer-executable instructions. In some instances, an action selection output 816a can include other data indicative of a selected action, such as an action name, action identifier (e.g., numerical identifier, token, etc.), action description, action parameters, or the like. For example, in some instances, a computing system or tool 840 can receive an action selection output 816a that does not comprise executable computer code, and can execute one or more operations based on the action selection output 816a. As a non-limiting illustrative example, a computing system or tool 840 can include glue code configured to receive an action selection output 816a comprising an action name; and perform, based on the action selection output 816a, an action 842 identified by the action name.

In some instances, causing the tool 840 to perform the action can include mapping the action selection output 816a to corresponding executable code (e.g., corresponding application programming interface (API) call, etc.) and executing the executable code. In some instances, mapping an action selection output 816a to executable code can include retrieving corresponding executable code (e.g., corresponding API call, etc.) from a data structure (e.g., database, table, row, column, file, object, etc.) based at least in part in part on the action selection output 816a (e.g., based on an action identifier, etc.). In some instances, mapping the action selection output 816a to executable code can include passing the action selection output 816a to glue code (e.g., glue code comprising one or more compiler, interpreter, or parser functions, etc.) configured to map action selection output 816a to executable actions.

In some instances, an output of a GUI interaction model 812 can be processed to identify and carry out action(s) associated with an action selection output 816a. For example, in some instances, a computing system can parse an action selection output 816a (e.g., based on delimiter tags such as “[Act]:” and “[Finish]:”), and one or more action selection outputs 816a can be extracted from the parsed output. In some instances, the parsed output can be checked for correctness (e.g., correct syntax, valid tool name, valid tool inputs, etc.). If a valid action selection is detected, a computing system may cause a tool 840 to perform the selected action. As a non-limiting illustrative example, in some instances, an action selection output 816a can include a first delimiter indicative of an action selection or tool 840 selection (e.g., “[Act]:”, etc.) followed by data (e.g., text data, language data, binary data, sequence data, etc.) indicative of a tool 840 selection, action selection, action or tool parameters, inputs to a tool or function, or the like. In some instances, parsing an action selection output 816a can include parsing based on the first delimiter (e.g., using a regular expression comprising data indicative of the first delimiter, etc.) to extract an action selection or tool selection output segment; parsing the action/tool selection output segment to extract one or more of an action identifier (e.g., name, etc.) or tool identifier, action or tool parameter(s), and input(s) to a tool or function; and performing a selected action based on the extracted data (e.g., based on a mapping from a tool identifier to an API function; based on a mapping from tool parameters or inputs to corresponding parameters of the API function; etc.).

A tool 840 can be or include one or more software, firmware, or hardware components configured to perform actions identified in an action selection output 816a. In some instances, a tool 840 can include a tool configured to perform one or more GUI interactions, such as a tool 840 configured to input one or more keyboard inputs based on an action selection output 816a; a tool 840 configured to input one or more touchscreen inputs, mouse inputs, or the like based on an action selection output 816a; or other GUI interaction tool 840.

In some instances, a tool 840 can include one or more API tools having an application programming interface (API) that can be called to invoke the API tool. In some instances, a tool 840 can include a tool 840 that is executed or invoked in another manner, such as a tool 840 comprising glue code configured to receive an action selection output 816a and perform one or more actions identified by the action selection output 816a. In some instances, an API of an API tool can be called directly by a GUI interaction model 812, or by another component (e.g., software, firmware, or hardware component, such as glue code, interpreter, compiler, etc.) based on action selection output(s) 816a of the GUI interaction model 812.

An API tool can include, for example, any tool (e.g., hardware tool, software tool, firmware tool, etc.) that can be accessed via an API. For example, in some instances, an API tool 840 can include software (e.g., application, operating system, etc.) installed on a device (e.g., mobile device, smartphone, etc.) running the GUI interaction model 812; software available via a network (e.g., internet); hardware devices (e.g., internet-connected hardware devices, Bluetooth-connected hardware devices, etc.); etc. In some instances, a hardware API tool can include a hardware tool connected (e.g., via a network, via a wireless or wired connection, etc.) to a device running the GUI interaction model 812. In some instances, an API tool can include a navigation API (e.g., map-related API, global positioning system-related API, etc.); a communication API (e.g., API associated with making phone calls, emails, or text messages such as SMS or MMS;

APIs associated with communication applications, such as messaging applications, social media communication applications, etc.); a scheduling API (e.g., calendar, alarm, automated task scheduling, etc.); media player API (e.g., video player such as YouTube, audio player, etc.); shopping API; payment API such as Google Pay; mobile banking API; travel-related API (e.g., flight booking, hotel booking, etc.); or API of any application installed on a mobile device. In some instances, an API tool can include a hardware device such as a Bluetooth-connected lock, gate opener, garage door opener, etc.; an internet-connected doorbell or surveillance camera device; smart home device such as smart TV, smart appliance, lighting devices, thermostats, etc.; or any other API-accessible hardware tool.

In some instances, a tool 840 can include a tool 840 configured to perform one or more operations that may include a machine learning component, such as image processing (e.g., machine-learned image processing; image generation, visual question answering, visual identification such as facial recognition, image captioning, etc.), audio processing (e.g., machine-learned image processing; audio generation such as speech or music generation, speech-to-text or text-to-speech processing, audio identification such as voice identification, etc.), video processing (e.g., video generation, etc.), sequence processing (e.g., natural language sequence generation, natural language translation, question answering, computer code generation, etc.), robotics (e.g., robotic systems comprising machine-learned agent(s) configured to control physical manipulation tools, etc.), mobile digital assistants (e.g., smart phone assistants configured to perform communication actions, navigation actions, calendar actions, smart appliance control actions, etc.) or other action type. Other tool types are possible.

An action 842 can include, for example, one or more computer-executable operations performed by one or more tools 840. For example, in some instances, an action 842 can include an action indicated by one or more action selection outputs 816a and performed by one or more tools responsive to receiving the action selection output(s) 816a.

In some instances, systems and methods depicted herein with respect to FIG. 8 can be combined with component(s) described with respect to other Figures, such as FIG. 1.

For example, in some instances, a combined input context 810 can be determined in any manner described herein with respect to FIG. 1 and combined input context(s) 110, and an inference output 816a, 816b can be used in any manner described herein with respect to FIG. 1 and inference output(s) 116.

### Example Methods

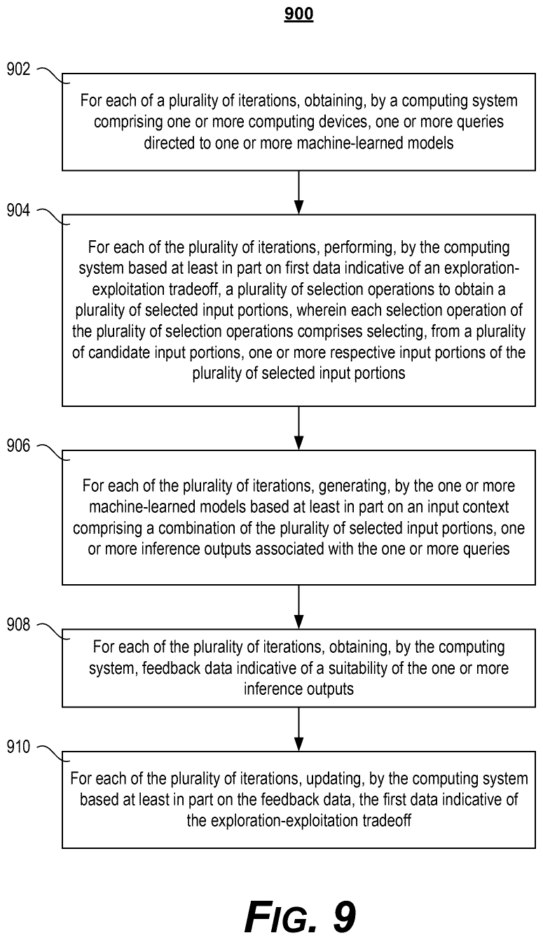

FIG. 9 depicts a flowchart diagram of an example method for input portion selection according to example embodiments of the present disclosure. Although FIG. 9 depicts steps performed in a particular order for purposes of illustration and discussion, the methods of the present disclosure are not limited to the particularly illustrated order or arrangement. The various steps of example method 900 can be omitted, rearranged, combined, and/or adapted in various ways without deviating from the scope of the present disclosure.

At 902, example method 900 can include, for each of a plurality of iterations, obtaining, by a computing system comprising one or more computing devices, one or more queries (e.g., queries 114, etc.) directed to one or more machine-learned models (e.g., machine-learned model 112, 512, 612, 712, 812, etc.). In some instances, example method 900 at 902 can include using one or more systems or performing one or more activities described with respect to FIGS. 1-8.

At 904, example method 900 can include, for each of the plurality of iterations, performing, by the computing system based at least in part on first data (e.g., exploration-exploitation data 104, 304, 404b, etc.) indicative of an exploration-exploitation tradeoff, a plurality of selection operations to obtain a plurality of selected input portions (e.g., input portions 106, etc.), wherein each selection operation of the plurality of selection operations comprises selecting, from a plurality of candidate input portions (e.g., candidate input portions 124, 224, etc.), one or more (e.g., one, etc.) respective input portions (e.g., first input portion 106 a, second input portion 106b, Kth input portion 106c, etc.) of the plurality of selected input portions. In some instances, example method 900 at 904 can include using one or more systems or performing one or more activities described with respect to FIGS. 1-8.

At 906, example method 900 can include, for each of the plurality of iterations, generating, by the one or more machine-learned models based at least in part on an input context (e.g., combined input context 110, 610, 710, 810, etc.) comprising a combination of the plurality of selected input portions, one or more inference outputs associated with the one or more queries. In some instances, example method 900 at 906 can include using one or more systems or performing one or more activities described with respect to FIGS. 1-8.

At 908, example method 900 can include, for each of the plurality of iterations, obtaining, by the computing system, feedback data indicative of a suitability of the one or more inference outputs. In some instances, example method 900 at 908 can include using one or more systems or performing one or more activities described with respect to FIGS. 1-8.

At 910, example method 900 can include, for each of the plurality of iterations, updating (e.g., according to update(s) 120, etc.), by the computing system based at least in part on the feedback data, the first data indicative of the exploration-exploitation tradeoff. In some instances, example method 900 at 910 can include using one or more systems or performing one or more activities described with respect to FIGS. 1-8.

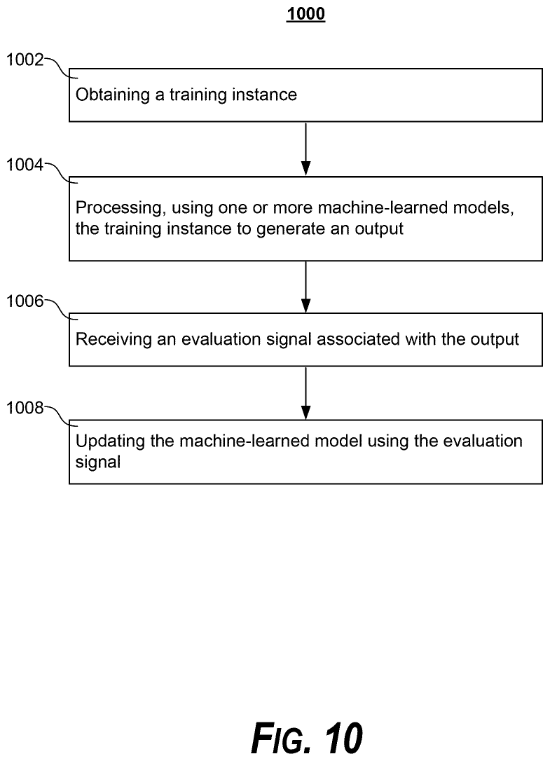

FIG. 10 depicts a flowchart of a method 1000 for training one or more machine-learned models according to aspects of the present disclosure. For instance, an example machine-learned model can include a machine-learned model 112.

One or more portion(s) of example method 1000 can be implemented by a computing system that includes one or more computing devices such as, for example, computing systems described with reference to the other figures. Each respective portion of example method 1000 can be performed by any (or any combination) of one or more computing devices.

Moreover, one or more portion(s) of example method 1000 can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of example method 1000 can be performed additionally, or alternatively, by other systems.

At 1002, example method 1000 can include obtaining a training instance. A set of training data can include a plurality of training instances divided between multiple datasets (e.g., a training dataset, a validation dataset, or testing dataset). A training instance can be labeled or unlabeled. Although referred to in example method 1000 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1004, example method 1000 can include processing, using one or more machine-learned models, the training instance to generate an output. The output can be directly obtained from the one or more machine-learned models or can be a downstream result of a chain of processing operations that includes an output of the one or more machine-learned models.

At 1006, example method 1000 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning).

The evaluation signal can be a reward (e.g., for reinforcement learning). The reward can be computed using a machine-learned reward model configured to generate rewards based on output(s) received. The reward can be computed using feedback data describing human feedback on the output(s).

At 1008, example method 1000 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1000 can include implementing a number of generalization techniques (e.g., weight decays, dropouts, etc.) to improve the generalization capability of the models being trained.

In some implementations, example method 1000 can be implemented for training a machine-learned model from an initialized state to a fully trained state (e.g., when the model exhibits a desired performance profile, such as based on accuracy, precision, recall, etc.).

In some implementations, example method 1000 can be implemented for particular stages of a training procedure. For instance, in some implementations, example method 1000 can be implemented for pre-training a machine-learned model. Pre-training can include, for instance, large-scale training over potentially noisy data to achieve a broad base of performance levels across a variety of tasks/data types. In some implementations, example method 1000 can be implemented for fine-tuning a machine-learned model. Fine-tuning can include, for instance, smaller-scale training on higher-quality (e.g., labeled, curated, etc.) data.

Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning.

Reinforcement learning can be based on user feedback on model performance during use.

### Example Machine-Learned Models

FIG. 11 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), chemical or biochemical data, image data, audio data, audiovisual data, haptic data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and astronomical data, sensor data and chemical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

FIG. 12 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components.
Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai. google/static/documents/palm2techreport. pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM:

Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 12 can be the tokens or can be the embedded representations thereof.

Prediction layer(s) 6 can predict one or more output elements 7-1, 7-2,. 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

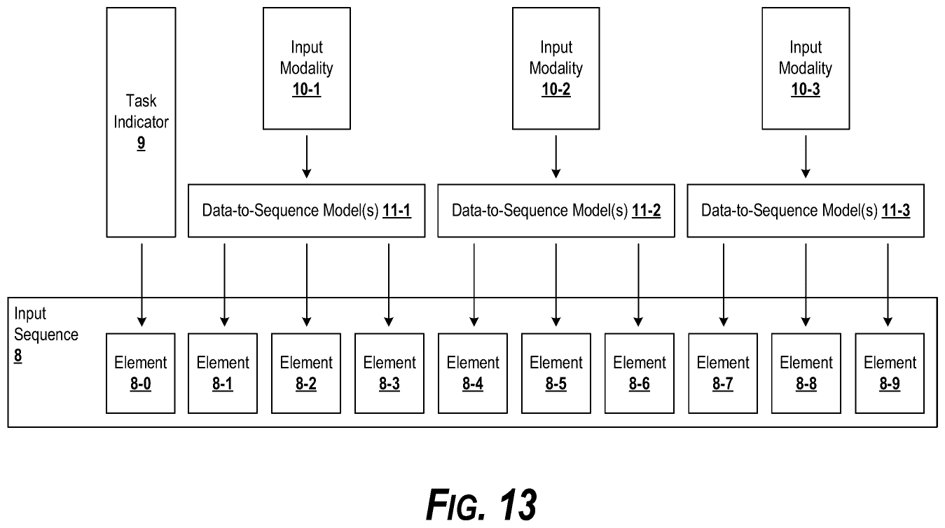

FIG. 13 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space.

For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4.

Data-to-sequence models 11-1, 11-2, and 11-3 can be trained end-to-end with machine-learned sequence processing model(s) 4.

### Example Machine-Learned Model Development Platform

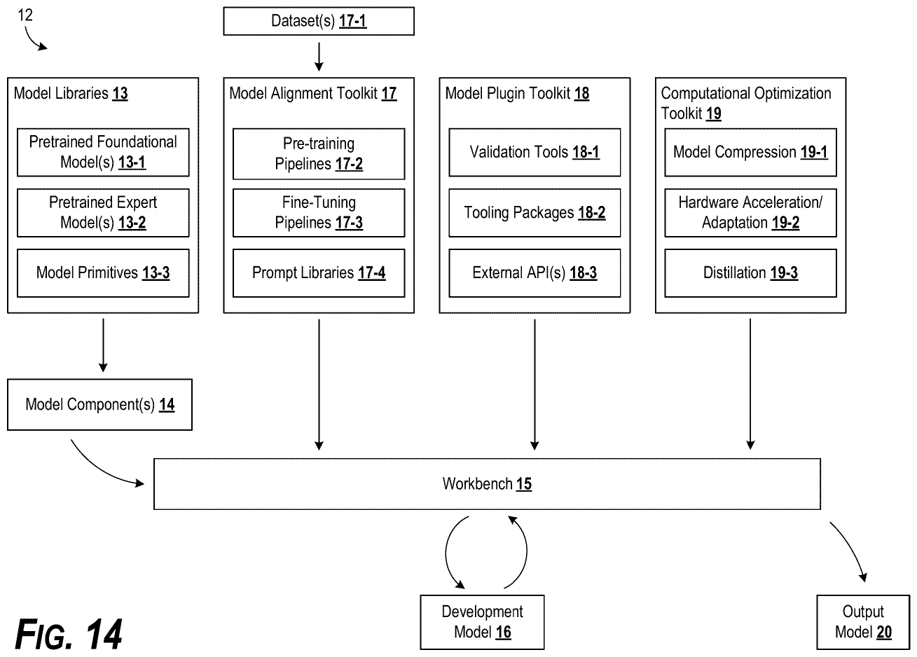

FIG. 14 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values.

Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1000 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models-e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

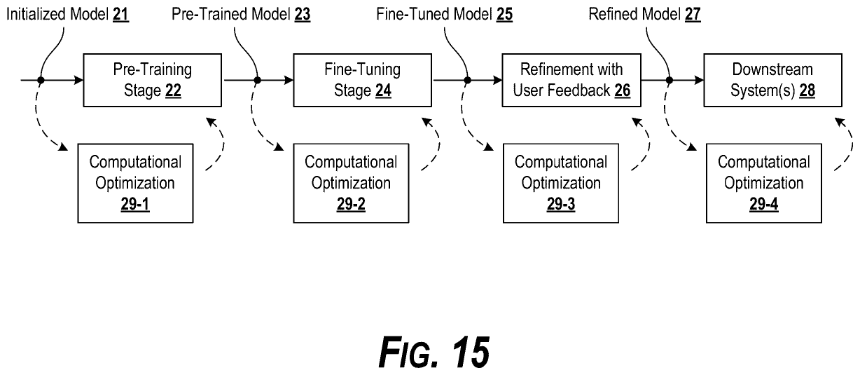

FIG. 15 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 15 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 15 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 25 can then be a new version of development model 16, which can persist as development model 16 or as a new development model. Fine-tuned model 25 can be the initial state if development model 16 was already fine-tuned. Fine-tuned model 25 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

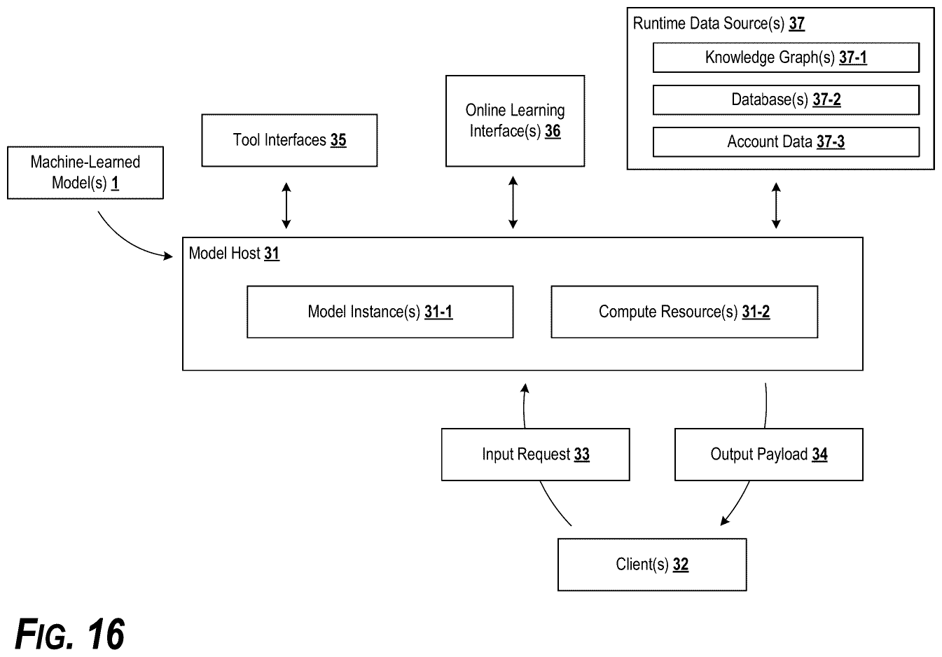

FIG. 16 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

FIG. 17 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 17 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52.

Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 17 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

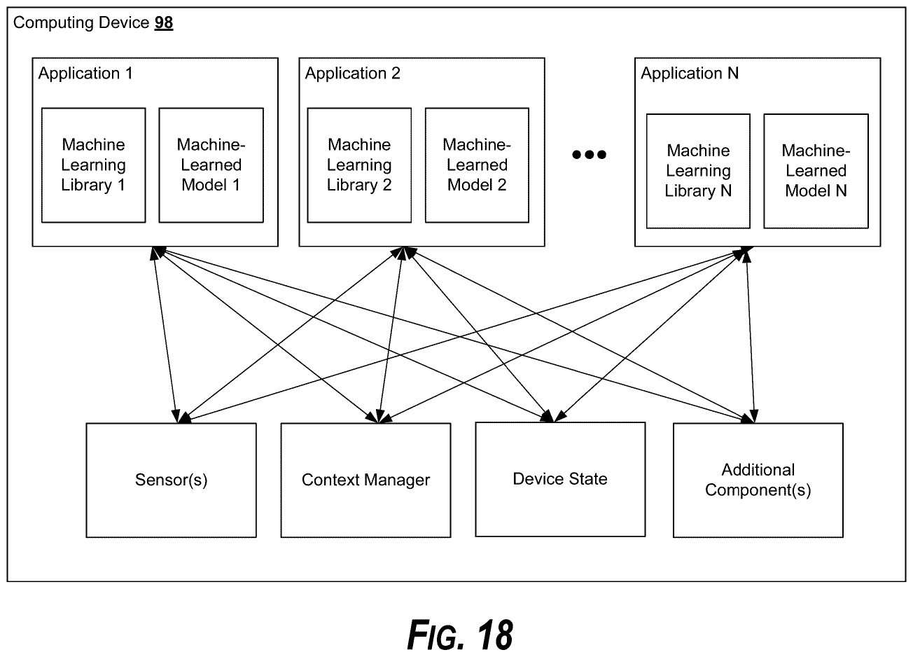

FIG. 18 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 18, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

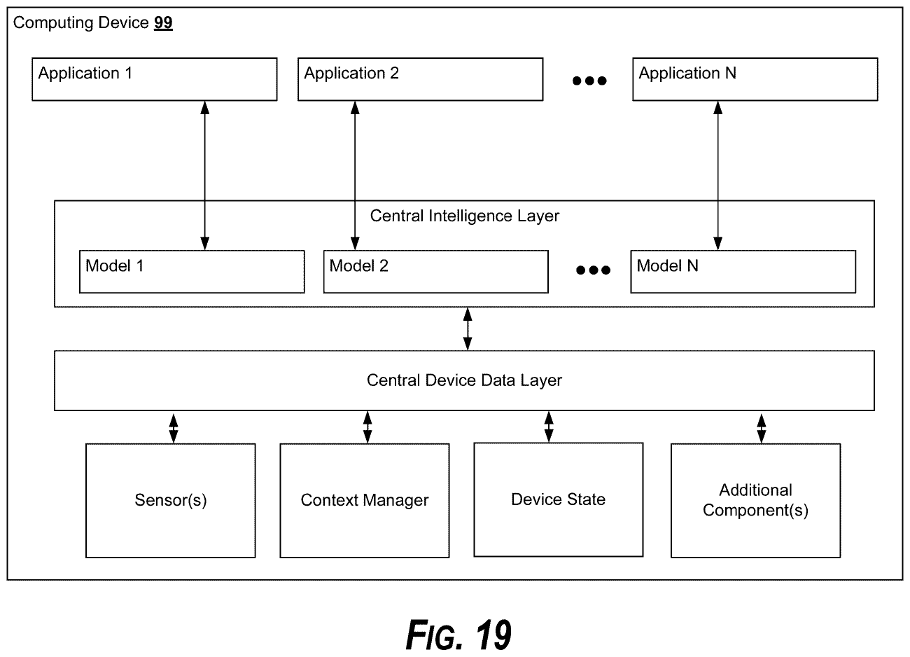

FIG. 19 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 19, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 19, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

1. A method comprising:
for each of a plurality of prompt optimization iterations:
obtaining, by a computing system comprising one or more computing devices, one or more queries directed to one or more machine-learned models;
selecting, by the computing system according to a combinatorial multi-armed bandit operation, a plurality of selected prompt components from a pool of candidate prompt components, wherein the combinatorial multi-armed bandit operation comprises:
a first plurality of exploitation selections, wherein each exploitation selection comprises selecting a high-performing prompt component based at least in part on past feedback data indicative of a suitability of one or more past inference outputs generated based on past prompt combinations comprising the high-performing prompt component; and
a second plurality of exploration selections, wherein each exploration selection comprises sampling a respective prompt component based at least in part on a random process;
providing, by the computing system to the one or more machine-learned models, a combined prompt comprising the plurality of selected prompt components;
generating, by the one or more machine-learned models based at least in part on the combined prompt and the one or more queries, one or more new inference outputs associated with the one or more queries;
obtaining, by the computing system, new feedback data indicative of a suitability of the one or more inference outputs; and
updating, by the computing system based at least in part on the new feedback data, the past feedback data.

2. The method of claim 1, wherein the pool of candidate prompt components is a first pool of candidate prompt components, and further comprising:
selecting, by the computing system prior to performing the plurality of selection operations, the first pool of candidate prompt components from a second, larger pool of candidate prompt components, wherein the first pool of candidate prompt components is a subset of the second pool of candidate prompt components.

3. The method of claim 2, wherein selecting the first pool of candidate prompt components comprises deduplication based at least in part on a metric of similarity between pairs of candidate prompt components of the second pool of candidate prompt components.

4. The method of claim 2, wherein selecting the first pool of candidate prompt components comprises clustering the second pool of candidate prompt components.

5. The method of claim 1, wherein the pool of candidate prompt components input portions is a first pool of candidate prompt components, wherein the one or more machine-learned models are one or more first machine-learned models, and further comprising:
generating by the computing system using the one or more first machine-learned models or the one or more second machine-learned models and based at least in part on one or more example prompt components, at least a portion of the first pool of candidate prompt components.

6. The method of claim 1, wherein at least one selection of the first plurality of exploitation selections and the second plurality of exploration selections comprises:
a diversity-based selection based at least in part on a metric of similarity between one or more already-selected prompt components and one or more not-yet-selected prompt components of the pool of candidate prompt components.

7. The method of claim 1, wherein at least one selection of the first plurality of exploitation selections and the second plurality of exploration selections comprises a query-dependent selection selecting based at least in part on a metric of similarity between the one or more queries and one or more candidate prompt components of the pool of candidate prompt components.

8. The method of claim 7, wherein the metric of similarity comprises a metric of distance between a first machine-learned embedding associated with the one or more queries and a second machine-learned embedding associated with the one or more candidate prompt components.

9. The method of claim 1, wherein selecting the plurality of selected prompt components the comprises:
selecting a proportion of exploitation selections and exploration selections based at least in part on an exploration parameter indicative of a degree to which exploration is to be prioritized in a current prompt optimization iteration of the plurality of prompt optimization iterations.

10. The method of claim 1, wherein selecting the plurality of selected prompt components comprises:
processing, by the computing system based at least in part on the one or more queries, the past feedback data to generate modified feedback data.

11. The method of claim 10, wherein processing the past feedback data comprises at least one of filtering the past feedback data and weighting the past feedback data, and wherein processing the past feedback data is based at least in part on at least one of a machine-learned embedding of the one or more queries, a category associated with the one or more queries, and a machine-learned output generated based on the one or more queries.

12. The method of claim 1, wherein the one or more machine-learned models comprise one or more multimodal vision-language machine-learned models, wherein the one or more queries comprise one or more natural language queries, and wherein each of one or more candidate prompt components of the pool of candidate prompt components comprises an image.

13. The method of claim 1, wherein the one or more machine-learned models comprise one or more multimodal machine-learned models, and wherein the pool of candidate prompt components comprises one or more multimodal prompt components.

14. The method of claim 1, wherein the one or more new inference outputs comprise at least one of:
one or more visual question answering outputs;
one or more graphical user interface automation outputs; and
one or more content recommendation outputs recommending one or more multimodal content items to provide responsive to the one or more queries.

15. The method of claim 1, further comprising, for each of the plurality of prompt optimization iterations:
selecting, by the computing system, at least one of:
a number of candidate prompt components to select;
an input template or input format for processing the selected prompt components;
a system prompt to be combined with the selected prompt components;
a tokenization method for tokenizing the one or more queries;
a diversity hyperparameter indicative of a degree to which a diversity of selected prompt components is to be prioritized in the first plurality of exploitation selections or second plurality of exploration selections;
a similarity hyperparameter indicative of a degree of similarity between the one or more queries and the selected prompt components; and
a selected method for combining the plurality of selected prompt components wherein the selected method is selected from a plurality of candidate methods comprising one or more of:
concatenation;
machine-learned combination using the one or more machine-learned models;
machine-learned combination using a different machine-learned model; and
combining a plurality of respective embedding values associated respectively with the plurality of selected prompt components.

16. The method of claim 1, wherein the plurality of selected prompt components comprise a plurality of example input-output tuples, each input-output tuple comprising an example input query and an example output associated with the example input query.

17. The method of claim 16, wherein the plurality of example input-output tuples comprise a plurality of input-reasoning-output tuples, each input-reasoning-output tuples comprising one or more example reasoning outputs associated with the example input query and the example output.

18. The method of claim 1, wherein the one or more machine-learned models comprise one or more first machine-learned models and one or more second machine-learned models, the plurality of prompt optimization iterations comprises a first plurality of prompt optimization iterations performed using the one or more first machine-learned models and a second plurality of prompt optimization iterations performed using the one or more second machine-learned models, and further comprising:
updating, by the computing system, an exploration parameter according to a refreshed exploration budget to increase a degree to which exploration is to be prioritized in one or more refreshed-exploration-budget iterations of the second plurality of prompt optimization iterations, wherein the one or more refreshed-exploration-budget iterations each comprise:
obtaining, by the computing system, one or more queries directed to one or more second machine-learned models different from the one or more first machine-learned models;
selecting, by the computing system according to the combinatorial multi-armed bandit operation based at least in part on the refreshed exploration budget and based at least in part on first-model past feedback data generated based on outputs of the one or more first machine-learned models, the plurality of selected prompt components;
providing, by the computing system to the one or more second machine-learned models, the combined prompt;
generating, by the one or more second machine-learned models the one or more inference outputs;
obtaining, by the computing system, the new feedback data; and
updating, by the computing system based at least in part on the new feedback data, the past feedback data.

19. A computing system comprising one or more processors and one or more non-transitory computer-readable media storing instructions that are executable by one or more processors to cause the computing system to perform operations, the operations comprising:
for each of a plurality of prompt optimization iterations:
obtaining one or more queries directed to one or more machine-learned models;
selecting, according to a combinatorial multi-armed bandit operation, a plurality of selected prompt components from a pool of candidate prompt components, wherein the combinatorial multi-armed bandit operation comprises:
a first plurality of exploitation selections, wherein each exploitation selection comprises selecting a high-performing prompt component based at least in part on past feedback data indicative of a suitability of one or more past inference outputs generated based on past prompt combinations comprising the high-performing prompt component; and
a second plurality of exploration selections, wherein each exploration selection comprises sampling a respective prompt component based at least in part on a random process;
providing, by the one or more machine-learned models, a combined prompt comprising the plurality of selected prompt components;
generating, by the one or more machine-learned models based at least in part on the combined prompt and the one or more queries, one or more new inference outputs associated with the one or more queries;
obtaining new feedback data indicative of a suitability of the one or more inference outputs; and
updating, based at least in part on the new feedback data, the past feedback data.

20. One or more non-transitory computer-readable media storing instructions that are executable by one or more processors to cause a computing system to perform operations, the operations comprising:
for each of a plurality of prompt optimization iterations:
obtaining one or more queries directed to one or more machine-learned models;
selecting, according to a combinatorial multi-armed bandit operation, a plurality of selected prompt components from a pool of candidate prompt components, wherein the combinatorial multi-armed bandit operation comprises:
a first plurality of exploitation selections, wherein each exploitation selection comprises selecting a high-performing prompt component based at least in part on past feedback data indicative of a suitability of one or more past inference outputs generated based on past prompt combinations comprising the high-performing prompt component; and
a second plurality of exploration selections, wherein each exploration selection comprises sampling a respective prompt component based at least in part on a random process;
providing, to the one or more machine-learned models, a combined prompt comprising the plurality of selected prompt components;
generating, by the one or more machine-learned models based at least in part on the combined prompt and the one or more queries, portions, one or more new inference outputs associated with the one or more queries;
obtaining new feedback data indicative of a suitability of the one or more inference outputs; and
updating, based at least in part on the new feedback data, the past feedback data.
